(19) United States
(12) Patent Application Publication
(10) Pub. No.: US 2016/0355444 A1
(43) Pub. Date: Dec. 8, 2016

(54) BIOMASS PROCESSING METHODS AND SYSTEMS

(71) Applicant: UNIVERSITY OF SASKATCHEWAN, Saskatchewan (CA)

(72) Inventors: Andrew A. OLKOWSKI, Saskatoon (CA); Bernard LAARVELD, Saskatoon (CA)

(21) Appl. No.: 15/109,064

(22) PCT Filed: Dec. 31, 2014
(86) PCT No.: PCT/IB2014/067432

§ 371 Date: Jun. 29, 2016

Related U.S. Application Data
(60) Provisional application No. 61/922,156, filed on Dec. 31, 2013.

(51) Int. Cl. C05F 3/00; C05D 1/00; C08H 7/00; C02F 1/72; C08B 37/00; D21C 11/00; C02F 1/66; C05F 3/06; C08B 15/02

(52) U.S. Cl. CPC C05F 3/00; C05F 3/06; C05D 1/00; C08H 6/00; C08B 15/02; C08B 37/00; D21C 11/00; D21C 11/0007; C02F 1/66; C02F 1/722; C02F 1/725; C02F 2103/20

(57) ABSTRACT

A process for producing desired compounds from biomass, including treating a lignocellulosic waste stream in some embodiments. The waste stream is conditioned under acidic or basic conditions, and is then treated in a catalytic reaction step using a transition metal catalyst and an oxidant. The transition metal catalyst can be an iron-based nanoparticulate catalyst. In some embodiments, useful compounds such as lignin, crystalline cellulose and various platform chemicals are produced from the waste stream. In some embodiments, the waste stream is lignocellulosic agricultural or forestry waste. In some embodiments, the waste stream is manure. In some embodiments, desirable bioproducts are obtained from lignocellulosic biomasses using an iron-based nanoparticulate-catalyzed reaction conducted at alkaline pH.

### TECHNICAL FIELD

Some embodiments of the present invention relate to systems or methods for processing biomass to produce desirable bioproducts. Some embodiments of the present invention relate to systems or methods for processing lignocellulosic waste to sterilize the waste and/or render it more effective in downstream applications such as agriculture or landscaping and/or reduce production of noxious and/or greenhouse gases during the processing of waste. Some embodiments of the present invention relate to systems or methods for processing biomass, including lignocellulosic biomass such as that produced by agriculture or forestry operations, to produce platform chemicals, lignin and/or crystalline cellulose. In some embodiments, the lignocellulosic biomass is manure from a commercial livestock operation.

### BACKGROUND

An important consequence of intensification of modern livestock production is the concentration of animals in limited space, leading to high amounts of manure to be managed in a limited space. This results in storage of large amounts of manure for extended periods of time.

Moreover, more recently manure has come to be viewed as a hazardous material, with identified problems including: 1) production of greenhouse gases and odious volatiles emissions, 2) presence of pathogenic microorganisms, 3) presence of drugs (e.g. antibiotics, hormones), and 4) concentration of toxins (e.g. PCB, phenolics, etc). Manure can have major impacts on lifestyle, the ecosystem, environment, and health.

Intensification of livestock production near urban centers has led to considerable social conflict between producers and consumers, for a number of reasons including because of odors emitted from manure. Because livestock production can be concentrated near urban centers for many reasons, odors emitted from manure and potential biological and toxicological hazards have become a major socio-economic issue. One important socio-economic issue is contamination of soil, ground and surface water sources with human and animal pathogens commonly present in manure. One example illustrative of such problems occurred in Walkerton, Ontario, Canada in May 2000. A sudden outbreak of illness killed seven residents and left 2,300 people sick, which was frightening for the local residents, and shocking for rest of Canada. Subsequent inquiry showed that Walkerton's water supply was contaminated with Escherichia coli from cattle manure seeping into a town well.

In the past decade, food-borne disease outbreaks have increasingly been associated with the consumption of fresh vegetables and fruits contaminated with pathogens such as Escherichia coli O157:H7 and Salmonella enterica serovar Typhimurium (Sivapalasingam et al., 2004). Pathogen contamination of soil and produce has been identified as a major food hygiene risk associated with the use of manure as fertilizer, and in particular with produce from organic farming. Bovine manure and slurry are the main environmental sources of these pathogens. Because of the widespread presence of these pathogens in livestock operations, disposal of manure by application in the field can create a number of health problems. E. coli O157:H7 shed from healthy cattle can survive for extended periods of time in the environment (Semenov, et al., 2009; Jiang et al., 2002). The high risk for transmission of pathogens to soil may have serious implications in organic or conventional production of vegetables. Since many vegetables are consumed raw, the risk of illness associated with contaminated produce is very high indeed.

Escherichia coli O157:H7 has been implicated in a number of recent recalls and outbreaks of illness linked to the consumption of vegetables worldwide. Outbreaks of foodborne diseases associated with Escherichia coli O157:H7 have become an important public health problem in the United States. In recent years, an average of about 440 cases of this type of E. coli infection was reported annually in Canada. Recent outbreaks were reported in the Maritimes and Ontario in 2013.

Dissemination of pathogens naturally present in manure is of concern because of direct impact on human or animal health, including zoonosis (e.g. the spread of an infectious disease from animals to humans). Animal waste is a source of many pathogenic bacteria including Escherichia coli, Salmonella species, Campylobacter, Listeria, and the like. Manure sanitation, or preferably elimination of pathogens in manure is very desirable. In some jurisdictions manure sanitation is a safety requirement.

In addition to pathogens present in manure, genetic material, for example portions of deoxyribonucleic acid (DNA), ribonucleic acid (RNA) or plasmids encoding undesirable genes, for example, antibiotic resistance genes, may also be present in manure. In recent years, dissemination of antibiotic resistance genes via manure received considerable attention (Heuer et al., 2009; Heuer et al., 2011; Walczak and Xu, 2011, Wichmann et al., 2014). Resistance of pathogens to antibiotics may be acquired by transfer of resistance genes. Antibiotic resistance genes may be transferred from resistant bacteria to sensitive bacteria by horizontal gene transfer via conjugation, transduction, or transformation. Many antibiotic resistance genes reside on transmissible plasmids, facilitating their transfer. A plasmid is a small DNA molecule occurring in a cell, for example a bacterial cell, outside of chromosomal DNA. Plasmids are most commonly found in bacteria as small, circular, double-stranded DNA molecules. Plasmids can replicate independently.

When treating a waste stream, it is desirable to inactivate (for example, by destroying) such genetic molecules to minimize the risk that such genetic material may be transferred to new organisms with potentially undesirable results, for example, the transfer of antibiotic resistance genes between bacteria.

In addition to the health risks and nuisance smell associated with manure, microbial fermentation of waste streams such as manure results in the production of noxious gases and/or greenhouse gases. For example, cattle manure is a major contributor to overall greenhouse gas emissions in the atmosphere. Emissions of major concern include ammonia, nitrous oxide, methane, carbon dioxide, various volatile organic compounds, hydrogen sulfide, and particulate matter. Ammonia and hydrogen sulfide are the primary gases associated with undesirable odor. Hydrogen sulfide is also potentially fatal. The odor threshold has been reported to be around 0.011 mg/m³ (0.008 ppm) in naïve subjects, but olfactory paralysis occurs at greater than about 140 mg/m³ (100 ppm). The loss of odor perception makes hydrogen sulfide especially dangerous, since a few breaths at around 700 mg/m³ (500 ppm) is lethal. Respiratory failure is the most common cause of death, but a wide range of health effects have been reported following exposure to high concentrations of hydrogen sulfide including respiratory, neurological and cardiovascular effects. There is a general consensus that hydrogen sulfide emission during manure storage presents a significant hazard for both animals and humans. Many fatalities due to exposure to hydrogen sulfide present in manure have been reported. Limits of exposure to this gas are defined by national and international agencies (e.g. IPSC, 2003; ATSDR, 2006).

It is desirable to provide methods of managing waste streams that reduce the production of noxious and/or greenhouse gases.

Animal manure may contain a wide range of biologically active compounds (e.g. hormones, drugs, pesticides, environmental contaminants, and the like) that can have adverse effects in humans and animals. Among contaminants of concern are veterinary drugs excreted via feces and urine, and naturally produced hormones (Zheng et al., 2008; Combalbert et al., 2012). In addition, manure has been found to contain many common pollutants such as nonylphenols, phthalates and bisphenol A, polycyclic aromatic hydrocarbons, dioxins, and the like (Tolls et al., 1994; Fromme et al., 2002; Ciganek and Neca, 2008; Ciganek et al., 2002). These compounds may be present in feed, environment, disinfection and cleaning materials, and storage containers, and may be concentrated in manure in significant quantities. Many compounds present in manure are of particular concern because of their capacity to induce strong endocrine responses (Andersen et al., 2003; Desbrow et al., 1998; Irwin et al., 2001; Kjaer et al., 2007). A recent study by Combalbert et al., (2012) showed diverse endocrine activities detected during manure storage which were poorly neutralised during manure storage, but were efficiently removed by aerobic treatment of manure.

Methods for management of manure available to livestock producers are very limited. Studies concerning manure management are mostly focused on the impact of manure on the environment (water quality, odor problems, air quality, etc.), but the information and methods on how to effectively deal with these problems are very inadequate. The presently practiced methods are primarily based on manure additives with variable effectiveness, manure separation methods, composting, and anaerobic digesters, with various reactor configurations for example fixed-film reactors, anaerobic biological reactors, batch reactors, fixed dome plants, continuously stirred tank reactors, and the like.

The foregoing are merely illustrative examples of the broader problems caused by pathogens found in animal manure. In view of the growing problems associated with intensive livestock operations, currently used manure storage and disposal methods are not effective at addressing the growing sanitary, toxicological, environmental, and socio-economic problems caused by manure. There remains a need for technologies to deal with manure management issues. There also remains a need for environmentally sensitive means of disposing of other waste streams such as municipal sewage and industrial waste streams.

In addition to methods for processing lignocellulosic waste such as manure, there is a need for improved methods for producing desirable end products such as crystalline cellulose and lignin from lignocellulosic biomasses generally. While methods for processing lignocellulosic biomass to produce desirable end products such as crystalline cellulose and lignin have been developed, for example as described in Patent Cooperation Treaty application publication No. 2013/000074, which is incorporated by reference herein, these methods are more effective on certain types of biomass than others. Some biomasses have a particularly complex lignocellulosic matrix, a high content of non-lignocellulosic material, and/or contain various biological contaminants. For example, manure has a high content of a complex biological matrix, and organic and mineral contaminants, and is a very important agricultural lignocellulosic biomass. Manure is often mixed with other recalcitrant biomasses that serve as bedding for animals. Other recalcitrant biomasses such as woody material, cereal grain straw, shives or hurd such as from flax and hemp straws, hulls, cotton gin waste, or various chaff, are not processed effectively through the processes described in WO 2013/000074, and require a harsh pretreatment step with performic acid in order to provide a high quality end product and/or a high yield of desired end product, whereas other types of high quality biomasses such as flax or hemp bast fiber are more readily processed by such processes.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a process for treating a waste stream in which the waste stream is subjected to a conditioning step under acidic or basic conditions, and is then subjected to a catalytic reaction step using a transition metal catalyst and hydrogen peroxide to produce a treated waste stream. In some embodiments, the transition metal catalyst is an iron-based nanoparticulate catalyst.

In some embodiments, the treated waste stream is used as a fertilizer, for example in agricultural, horiticultural or landscape applications. In some embodiments, the treated waste stream is further processed to obtain desired bioproducts from the waste stream. In some embodiments, the desired bioproducts are lignin, hemicellulose, cellulose or crystalline cellulose.

In some embodiments, a process for recovering bioproducts from lignocellulosic biomass, including recalcitrant biomass, without the use of a harsh pretreatment step, for example using performic acid, is provided. In some embodiments, the lignocellulosic biomass is combined with a trace amount of a transition metal catalyst, a polyvalent carboxylic acid and hydrogen peroxide at acidic pH to initiate a catalytic reaction, and the pH is then increased to an alkaline pH. Lignin and hemicellulose are optionally recovered from the liquid fraction, and cellulose is recovered from the solid fraction. The recovered cellulose is optionally subjected to a further catalytic reaction by combining the recovered cellulose with a transition metal catalyst and hydrogen peroxide at acidic pH, optionally in the presence of a polyvalent carboxylic acid, to provide improved recovery of crystalline cellulose. In some embodiments, the transition metal catalyst used in one or both steps of the catalytic reaction is an iron-based nanoparticulate catalyst.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows the general steps in one example embodiment of a method for processing a waste stream.

FIG. 2 shows the general steps in one example embodiment of a method for producing valuable products from a waste stream.

FIG. 3 shows the general steps in one example embodiment of a method for producing the valuable products lignin and crystalline cellulose from a waste stream.

FIG. 4 shows an example design of a manure processing module.

FIG. 5 shows the general steps in one example embodiment of a method for producing bioproducts from lignocellulosic biomass.

FIG. 6 shows dissolved oxygen levels in complete reaction medium containing an iron-based nanoparticulate catalyst and hydrogen peroxide; medium containing iron-based nanoparticulate catalyst without hydrogen peroxide, and water containing 0.35% hydrogen peroxide.

FIG. 7 shows photographs showing the effect of treatment with an iron-based nanoparticulate catalyzed reaction in manure slurry amended with wheat straw. Sample #1 is the sample subjected to treatment with complete catalytic reaction medium including iron-based nanoparticulate catalyst and hydrogen peroxide in a citrate buffer. Sample #2 is the sample subjected to treatment with only the iron-based nanoparticulate catalyst in a citrate buffer. Sample #3 is a control sample diluted with water to the same volume as samples #1 and #2.

FIG. 8 shows the effects of manure slurry conditioning with or without complete iron-based nanoparticulate catalyzed reaction.

FIG. 9 shows pressure developing in a reaction bottle containing raw (untreated) manure slurry. Photographs were taken at 14 days (panel a), 23 days (panel b), 26 days (panel c) and 29 days (panel d).

FIG. 10 shows representative cultures on plates inoculated with 50 microliters of untreated manure slurry (left plate) and 50 microliters of manure slurry treated with iron-based nano-particulate catalytic reaction (right plate).

FIG. 11 shows microscopic images of raw (untreated) slurry and slurry subjected to iron-based nano-particulate catalytic reaction under alkaline conditions. Both samples were incubated for 14 days at room temperature.

FIG. 12 shows a photograph of lignin briquettes obtained from manure using a hot alkaline extraction process followed by filtration and air drying.

FIG. 13 shows the FTIR spectra of lignin obtained from a manure sample, superimposed with the FTIR spectra of highly purified commercially obtained lignin.

FIG. 14 shows a photograph of a prototype of a small scale-up manure treatment reactor.

FIG. 15 shows examples of DNA gel electrophoresis loaded with DNA marker (lane 1), pUC19 untreated control (lane 2), and pUC19 treated with iron-based nanoparticulate catalytic reaction (lane 3).

FIG. 16 shows the results of a comparative study of dissolved oxygen generation in alkaline solution at pH 12.2.

FIG. 17 shows images of (a) wheat straw, (b) oat hulls, and (c) flax shives biomass processed using a catalytic reaction step only at acidic pH (left panel) or using a catalytic reaction step conducted at alkaline pH (right panel, a1, b1, and c1, respectively).

FIG. 18 shows light microscope images of crystalline cellulose obtained from flax shives biomass processed with a catalytic reaction step conducted only at acidic pH (panel a), or using a catalytic reaction step including an alkaline catalytic reaction step (panels b, c and d).

FIG. 19 shows light microscope images of crystalline cellulose obtained from (a) manure, (b) wheat straw, (c) oat hulls, and (d) cotton gin waste using a catalytic reaction conducted at alkaline pH. Crystalline cellulose crystals were photographed under dark field.

FIG. 20 shows an example of X-ray diffraction spectra of crystalline cellulose prepared from manure using a catalytic processing step conducted at alkaline pH. The tracing denotes the spectrum prior to de-convolution, and colored shading represent peaks identified using the minimum second derivative method.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

According to some embodiments of the present invention, methods and apparatus are provided to process waste, including lignocellulosic waste, including manure from livestock operations, in a manner that provides one or more of: control of the production of odorous gases; control of the production of toxic gases (e.g. ammonia, hydrogen sulfide) and/or greenhouse gas emissions (e.g. methane and nitrous oxide); control of pathogenic microorganisms; control of toxins and drugs (e.g. antibiotics, hormones) found in waste; control of genetic material (e.g. DNA, RNA or plasmids) found in waste; and, breakdown of complex organic molecules in the biomass to smaller molecules more readily utilized by growing plants.

Some embodiments of the present invention provide systems or methods for sterilizing waste streams, e.g. by killing and/or inactivating pathogenic microorganisms present in the waste stream. Some embodiments provide systems or methods for treating a waste stream while reducing the production of odorous volatile compounds and/or greenhouse gases caused by microbial fermentation of a waste stream. Some embodiments provide systems or methods for breaking down complex particulate matter in a waste stream. Some embodiments provide systems or methods for breaking down contaminants present in a waste stream, including genetic material, toxic compounds, antibiotics, hormones, and drugs. Some embodiments provide systems or methods for producing platform chemicals, lignin and/or crystalline cellulose from a waste stream or other lignocellulosic biomass. In some embodiments, the waste stream is manure from a commercial livestock operation.

As used herein, “crystalline cellulose” includes both microcrystalline cellulose and nanocrystalline cellulose. Crystalline cellulose is to be distinguished from cellulose, for example as found in Kraft pulp.

In some embodiments, the process includes a conditioning step under acidic or basic conditions to halt natural microbial fermentation processes in order to prevent synthesis and emission of odorous volatile compounds, and/or prevent generation of greenhouse gases. In some embodiments, the conditioned biomass is stored for a period of time after the conditioning step. The conditioned biomass is subjected to a catalytic degradation step to break down complex particulate matter. In some embodiments, the result of the conditioning step and catalytic degradation step is sanitation of a waste stream (i.e. pathogens in the waste stream are killed or inactivated). In some embodiments, the catalytic degradation step breaks down contaminants that may be present in a waste stream or other source of biomass such as genetic material (for example, DNA, RNA or plasmids), toxic compounds, heterocyclic aromatic molecules, antibiotics, hormones, and drugs. In some embodiments, the waste stream or another source of lignocellulosic biomass is subjected to further processing after the catalytic degradation step to yield valuable products such as lignin, hemicellulose, cellulose, crystalline cellulose, and/or various platform chemicals.

In some embodiments, the waste stream is lignocellulosic agricultural or forestry waste, for example, manure, woody material such as wood chips, sawdust, wood waste, pulping byproducts or other waste products produced by the pulp and paper industry, cereal grain straws, shives or hurd from flax or hemp straw, hulls including oat or rice hulls, cereal bran, grasses including Miscanthus (elephant grass), cotton gin waste, corn stover, corn husks, sugar cane bagasse, or various chaff, pulp from fruit and vegetable processing, or solid byproducts from fermentation, or the like.

In some embodiments, the waste stream is manure from an agricultural operation, e.g. from a cattle farm or dairy barn, pig farm, chicken, turkey, duck or other poultry barn, horse stable, sheep or goat farm, zoo, or other source of large quantities of manure. In some embodiments, the waste stream is an industrial effluent or the output of a municipal sewage facility.

In some embodiments, the catalytic degradation step uses a catalytic reaction based on a multistep process of serial and parallel reactions. Without being bound by theory, it is believed that the catalytic degradation step involves the decomposition of organic and inorganic matter in the presence of a catalyst, and oxygen and reactive oxygen species co-generated in the process. Since the catalysis involves an oxidative process (even under a reducing environment), some embodiments effectively decrease emission of greenhouse gases and odious volatile compounds to negligible levels as compared with previous treatment processes. Without being bound by theory, it is believed that the complex polymeric structures present in the waste stream are broken down by reactive oxygen species and, to a certain extent, hydrolysis. In some embodiments, the degradation process of complex polymeric structures by the catalytic degradation step comprises depolymerisation, first at the macro level, and then at the micro and nano levels.

In some embodiments, the catalytic degradation step involves the decomposition of organic and inorganic matter in the presence of a transition metal catalyst, for example an iron-based nanoparticulate catalyst described in WO 2013/000074, which is hereby incorporated by reference herein, and oxygen co-generated in the process. As outlined in WO 2013/000074, an iron-based nanoparticulate catalyst can be obtained by oxidizing a highly reduced solution of iron, such as groundwater that has not been exposed to oxygen. Upon oxidation, various elements in the water precipitate into nanoparticles or aggregates of nanoparticles, with a large population of nanoparticles or aggregates in the 50 to 200 nm range. The iron may be multivalent, i.e. possess more than one oxidation state, which may vary from zero to five. The core structure of the nanoparticulate catalyst can include calcium carbonate. As outlined in WO 2013/000074, the iron-based nanoparticulate catalyst increases the level of dissolved oxygen present in an aqueous catalytic reaction system containing hydrogen peroxide (H₂O₂).

Other transition metal catalysts that can be used in other embodiments of the present invention include any transition metal, which includes any element in the d-block of the periodic table, which includes groups 3 to 12 on the periodic table, including iron, nickel, copper or zinc. In other embodiments, the transition metal catalyst is a carbon nanotube (multi-walled or single walled), impregnated with a transition metal such as iron (Fe), copper (Cu), molybdenum (Mo), rhodium (Rh), cobalt (Co), or combinations thereof.

Without being bound by theory, the chemistry underlying the catalytic degradation step that provides robust and sustainable net generation of oxygen under conditions of acidic pH is believed to be as follows. The chemistry of the reactions can be described as a combination of at least two reactions i.e. the Fenton reaction and Haber-Weiss reaction.

Considering the classic Fenton reaction (Eq. 1) and Haber-Weiss reaction (Eqs. 2 and 3)

Fe²⁺+H₂O₂→Fe³⁺+OH.+OH⁻ 1)

H₂O₂+OH.→H₂O+O₂⁻+H⁺ 2)

H₂O₂+O₂⁻→O₂+OH.+OH⁻ 3)

then the superoxide (O₂⁻) radical generated (Eq. 2) in the presence of a transition metal will result in generation of oxygen as per the reactions shown in Eqs. 3 and 4.

Fe³⁺+O₂⁻→Fe²⁺+O₂ 4)

Further, in the presence of H⁺ ions, the reaction of superoxide (O₂⁻) will oxidize Fe²⁺ to Fe³⁺ (Eq. 5) and further will yield hydrogen peroxide and oxygen as indicated in Eq. 6.

Fe²⁺+O₂⁻+2H⁺→Fe³⁺+H₂O 5)

2O₂⁻+2H⁺→O₂+H₂O₂ 6)

The catalytic reaction system provides ideal chemical conditions for such reactions to occur in cyclic mode, with regeneration of Fe³⁺ and Fe²⁺ and regeneration of hydrogen peroxide (Eq. 6), and further generation of oxygen (Eq. 7).

H₂O₂+OH.+O₂⁻→O₂+H₂O+OH.+OH⁻H⁺ 7)

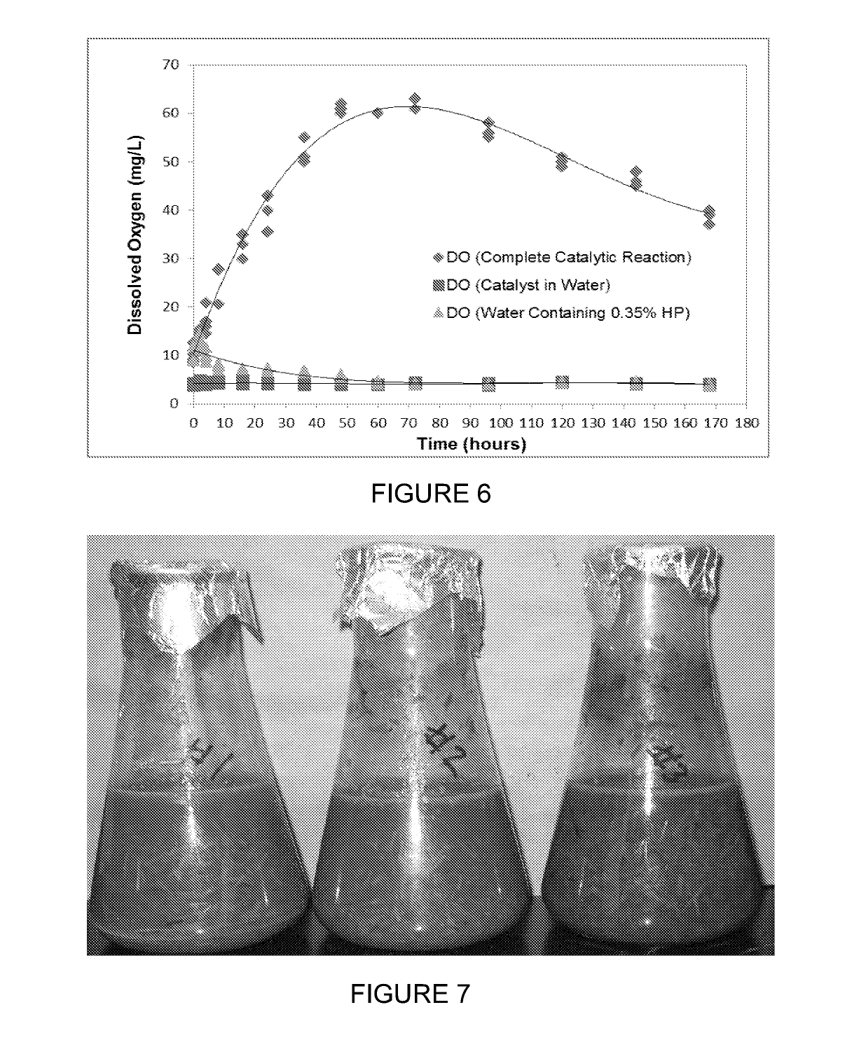

As evidenced by the pattern of dissolved oxygen generation shown in FIG. 6 discussed below, the above described catalytic reaction would be expected to provide sustained repletion of oxygen consumed by organic matter content of the waste material (e.g. manure). The generation of hydroxyl radicals (Eqs. 1, 3 and 7) and superoxide (Eq. 2) will aid in reduction of undigested plant components such as cellulose, hemicellulose, and lignin to basis constituents, which can provide a substrate for composting of biomass.

In some embodiments, the catalytic degradation step reduces or eliminates the generation of greenhouse gases and volatile odious gases from the waste stream being processed. In contrast, for example, currently used methods of manure processing (which tend to rely on fermentation) generate such gases abundantly.

Without being bound by theory, during the iron-based nanoparticulate catalyzed reaction, complex polymeric materials constituting manure biomass are hydrolyzed to smaller molecules. This process can provide better base material for assimilation of the resultant product after application as a fertilizer in soil. Because larger particles are decomposed at the catalytic reaction stage, the final product can be applied in liquid form for field irrigation, or dewatered and applied in the field in granular form, as desired.

Also, during the catalytic reaction step, complex molecules such as heterocyclic aromatic molecules, genetic material, toxins, antibiotics, hormones, drugs and the like can be broken down. Thus, in some embodiments, undesirable contaminants can be removed from a waste stream, including manure, to provide a fertilizer end product that is substantially free of undesirable contaminants such as heterocyclic aromatic molecules, genetic material, toxins, antibiotics, hormones, drugs and the like.

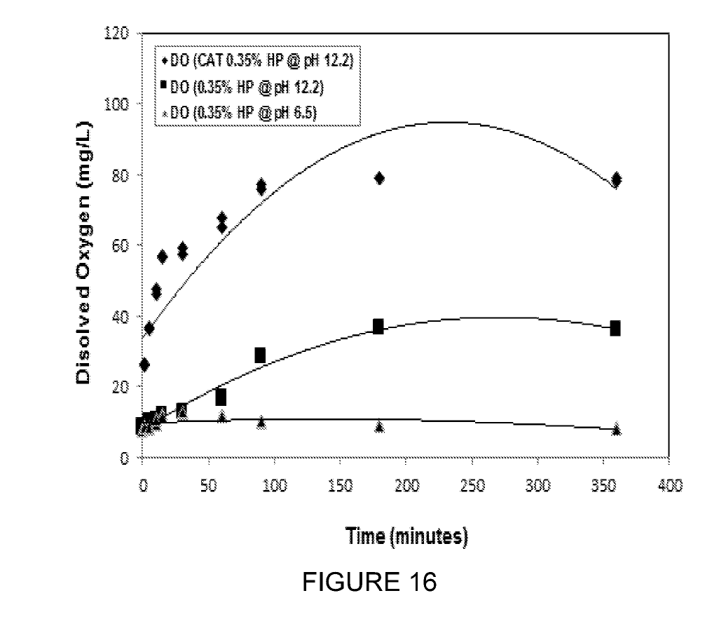

In some embodiments, at least a portion of the catalytic reaction step is conducted at alkaline pH. Unexpectedly, it was found that catalytic treatment of lignocellulosic biomass at alkaline pH using hydrogen peroxide and an iron-based nanoparticulate catalyst also results in the robust generation of oxygen, as illustrated in FIG. 16, discussed below. Under alkaline conditions, the robust generation of oxygen cannot be explained by the simple degradation of hydrogen peroxide according to Eq. 8:

2H₂O₂→2H₂O+O₂ 8)

In order to explain the apparent catalytic effects of iron at alkaline pH, it is necessary to consider generation of intermediates that would allow a cyclic reaction with the generation of oxygen, and at least partial regeneration of hydrogen peroxide. Without being bound by theory, the following equations are believed to provide an explanation for the observed efficacy of treating biomass with a catalytic reaction at alkaline pH.

The starting point is the classic Fenton reaction (Eq. 1) and Haber-Weiss reactions (Eqs. 2 and 3). Under acidic conditions, the first stage of the reaction, i.e. generation of Fenton and Haber-Weiss intermediates, may be considered a chain initiation step. In an exemplary catalytic reaction system using a citrate buffer with three ionizable groups in citric acid with pKₐ for carboxylic groups 1, 2, and 3 values 3.13, 4.76, and 6.40 respectively, provides chemical conditions for such reactions to occur in cyclic mode, with regeneration of Fe³⁺ and Fe²⁺ and regeneration of hydrogen peroxide.

Without being bound by theory, the redox chemistry of iron-polyvalent acid complexes deserves thorough analysis, because for example citrate-Fe(II)-dioxygen-citrate Fe(III) complexes are very potent catalysts that are not inhibited either by catalase or superoxide dismutase (SOD). It is possible that in the exemplary reaction system characterized in the examples herein, iron-citrate complexes formed may drive generation of at least some reactive intermediates typically expected in classic Fenton or Haber-Weiss reactions, but under a high pH environment. Other polyvalent carboxylic acids would be expected to behave similarly, for example oxalic acid has been characterized in the literature, and aconitate, maleate, glutarate or the like would be expected to be similar although with potentially differing levels of efficacy. Citrate is readily available, and can be obtained in food grade, and so was selected as an exemplary polyvalent carboxylic acid.

If the generation of intermediates is sustained in a high pH environment, then it is possible that hydroxyl radicals are generated in higher quantities, and may have a longer life span. In this situation several possible scenarios for interaction of these radicals can be considered. For instance hydroxyl radicals may react with Fe²⁺ and produce Fe³⁺ (Eq. 9).

OH.+Fe²⁺→Fe³⁺+OH— 9)

However, it is also possible that OH. could react with Fe³⁺ (Eqs. 10 & 11).

OH.+Fe³⁺→FeOH³⁺ 10)

OH.+Fe³⁺→Fe²⁺+OH⁻ 11)

Or hydrogen peroxide could react with Fe³⁺ or Fe²⁺ to produce Fe²⁺ (Eq. 12) and Fe³⁺ (Eq. 13).

H₂O_{2 +}Fe³⁺→Fe²⁺+OH.+OH⁻ 12)

H₂O₂₊Fe²⁺→Fe³⁺+OH.+OH⁻ 13)

Furthermore, it is possible for reactions (Eqs. 14 & 15) between H₂O₂ and iron(II) with the synthesis of ferryl ion (FeO²⁺), an oxidizing Fe(IV) species, as first suggested by Bray and Gorin (1932), and later confirmed by Ensing et al. (2002).

Fe²⁺+H₂O₂→FeO²⁺+H₂O 14)

FeO²⁺+H₂O₂→Fe²⁺+H₂O+O₂ 15)

This interaction could also produce an Fe-peroxo complex, Fe (II) HOO which may react further to generate either HO radical, a one-electron oxidant, or Fe (IV)═O, a two electron oxidant

(Masarwa et al., 1988).

It is also possible that hydrogen peroxide can react with hydroxyl groups to form intermediate hydroperoxide anion (Eq. 16), which then can react with hydrogen peroxide to form hydroxyl radical and superoxide ion (Eq. 17).

H₂O₂+OH⁻→HOO⁻+H₂O 16)

H₂O₂+HOO⁻→OH.+O₂⁻+H₂O 17)

Hydroxyl radicals can react to form hydrogen peroxide (Eq. 18) or react with hydrogen peroxide to form hydroperoxyl (Eq. 19).

OH.+OH.→H₂O₂ 18)

OH.+H₂O₂→HO₂.+H₂O 19)

Both oxygen and hydrogen peroxide can be generated from hydroperoxyl (Eq. 20).

HO₂.+HO₂.→H₂O₂+O₂ 20)

The above reactions are provided without being bound by theory only as a possible way to explain the observed efficacy of the catalytic reaction system under alkaline conditions. Based on the experimental results described herein, it is apparent that the alkaline catalytic process effectively removes lignin and hemicellulose from plant material, and thus allows extraction of crystalline cellulose from lignocellulosic biomasses. These effects are consistent with the action of reactive intermediates, and this process has been demonstrated by the inventors to facilitate extraction of high value bioproducts, including crystalline cellulose, from biomasses, including recalcitrant biomasses, without the need for a harsh pretreatment step such as performic acid treatment.

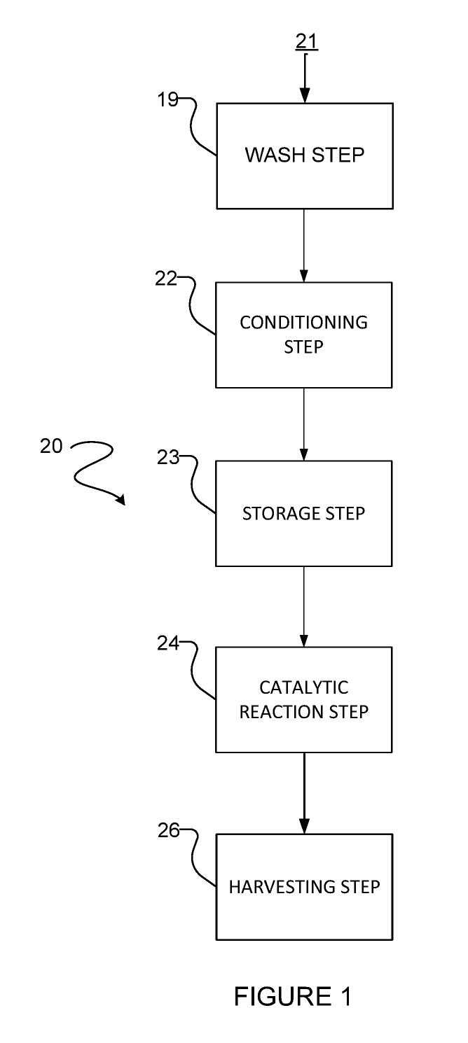

With reference to FIG. 1, an example embodiment of a process 20 for treating a waste stream fed into the process at 21 includes a wash step 19, a conditioning step 22, a catalytic reaction step 24, and a harvesting step 26. In some embodiments, an optional storage step 23 is provided following the conditioning step 22.

In some embodiments, waste stream 21 is manure from an agricultural operation, e.g. from a cattle farm or dairy barn, pig farm, chicken barn, turkey barn, duck farm, or other poultry operation, horse stable, sheep or goat farm, or other source of large quantities of manure, for example a zoo. In some embodiments, the waste stream is an industrial effluent or the output of a municipal sewage facility. In some embodiments, the chemicals that can be recovered from manure obtained from ruminant animals such as cattle, goats or sheep will differ from the chemicals that can be recovered from manure obtained from a monogastric animal such as a horse, pig, poultry, carnivore, human or the like, due to differences in the composition of the waste stream 21. In some embodiments, waste stream 21 is lignocellulosic agricultural or forestry biomass, for example manure, woody material such as wood chips, sawdust, wood waste, or pulping byproducts, cereal grain straws, shives or hurd from flax or hemp straw, hulls including oat or rice hulls, cereal bran, grasses, including Miscanthus grass (elephant grass), cotton gin waste, or various chaff, corn stover, corn husks, sugarcane bagasse, or the like.

In some embodiments, the dry matter content of the waste stream to be treated is in the range of about 2% to 20% or any value therebetween, e.g. 5%, 7%, 10%, 12%, 15% or 17%. In some embodiments, for example where conservation of water is an important concern, the dry matter content of the waste stream to be treated may be higher. In some embodiments, the waste stream 21 to be treated is relatively dry (e.g. a mixture of manure and bedding), and water is added to form a slurry and increase the water content of waste stream 21 to a desired level, e.g. in the range of about 2% to 20%, for treatment. In other embodiments, the dry matter content may be much lower, for example, pulp produced from fruit juice may have a dry matter content of less than about 50%.

In some embodiments, wash step 19 is conducted if necessary, with the waste being washed to eliminate undesired contaminants. In some embodiments, the waste is biomass produced from an agricultural or forestry operation.

The conditioning step 22 is now described in greater detail. In some embodiments, conditioning step 22 involves subjecting waste stream 21 to an acidic environment (e.g. having a pH of less than about 1.5). In some embodiments, conditioning step 22 involves subjecting waste stream 21 to an alkaline environment (e.g. having a pH in the range of 12 to 13).

Any suitable acid or base can be used to adjust the pH of waste stream 21 to subject waste stream 21 to an acidic or alkaline environment. In some embodiments, a strong acid or a strong base is used to adjust the pH of waste stream 21. In some embodiments, subjecting waste stream 21 to an alkaline environment comprises adding a sufficient amount of sodium hydroxide (NaOH), potassium hydroxide (KOH) and/or ammonium hydroxide (NH₄OH), or a combination thereof, to raise the pH of the waste stream to about 12 to 13. In some embodiments, subjecting waste stream 21 to an acidic environment comprises adding hydrochloric acid (HCl), nitric acid (HNO₃), sulfuric acid (H₂SO₄), phosphoric acid (H₃PO₄), or a combination thereof to reduce the pH of the waste stream to less than about 1.5.

In some embodiments, the addition of potassium hydroxide (KOH), ammonium hydroxide (NH₄OH), nitric acid (HNO₃), sulfuric acid (H₂SO₄) or phosphoric acid (H₃PO₄) for use in conditioning the waste stream during the conditioning step 22 increases the fertilizer value of the final product. For example, further treatment during conditioning or at another step in the waste processing process using customized titration of the processed waste stream with acids such as hydrochloric acid (HCl), nitric acid (HNO₃), sulfuric acid (H₂SO₄), and/or phosphoric acid (H₃PO₄), can be implemented as required to generate various valuable potash salts, also termed potassic fertilizers, such as potassium chloride (KCl), potassium sulfate (K₂SO₄), potassium nitrate (KNO₃), or potassium phosphates (KₓPO₄). Various potash salts are routinely used as fertilizers. Potash denotes a variety of mined and manufactured salts, all of which contain the element potassium in water-soluble form. Potash salts are in high demand for commercial crop agriculture, and for horticulture.

Thus, some embodiments can be designed to provide high quality, customized fertilizer product that will meet soil application requirements for practically any nitrogen-phosphorus-potassium (NPK) content and any pH range.

In some embodiments, the particular acid or base that is selected for use in the conditioning step 22 is selected based on a desire to provide a particular nutrient in a downstream product, for example a fertilizer product, produced from the waste stream. For example, in some embodiments in which it is desired to provide a fertilizer end product with a higher concentration of nitrogen, conditioning step 22 is conducted by adding nitric acid, optionally in combination with one or more other acids, to reduce the pH of waste stream 21 to less than about 1.5. In some example embodiments where it is desired to provide a fertilizer rich in phosphorus, conditioning step 22 is conducted by adding phosphoric acid, optionally in combination with one or more other acids, to reduce the pH of waste stream 21 to less than about 1.5. In some example embodiments where it is desired to provide a fertilizer rich in potash salts, conditioning step 22 is conducted by adding potassium hydroxide, optionally in combination with one or more other bases, to increase the pH of waste stream 21 to between about 12 and 13. In some embodiments, the acid or base that is used to conduct conditioning step 22 is selected so as to be non-toxic or acceptable for any downstream uses of the end product of waste processing, for example, as fertilizer.

In some embodiments, the determination of which acid(s) or base(s) should be used to conduct conditioning step 22 is made based on an economic analysis, e.g. by comparing the cost of each acid or base as a raw material and the value of the ultimate end product of using such acid or base, for example as a fertilizer. In some embodiments, the determination of which acid(s) or base(s) should be used to conduct conditioning step 22 is made based on reducing environmental impact by adjusting nitrogen and phosphorous levels in a waste stream such as manure to suit particular plant growth requirements. For example, manure is widely used as a fertilizer but may contain a much higher level of phosphorous relative to nitrogen versus what is required by a crop, which can result in environmental contamination due to the over-application of phosphorous if sufficient manure is provided to meet crop nitrogen requirements.

In some embodiments, the conditioning step can be conducted initially at acidic pH, and a strong base can be added to increase the pH to an alkaline pH. Alternatively, the conditioning step can be initially conducted at an alkaline pH, and a strong acid can be added to decrease the pH to an acidic pH. In some embodiments where it is desired to produce a fertilizer having a particular composition of compounds such as potassium, nitrogen and phosphorous, addition of various different compounds to change the pH from acidic to basic or from basic to acidic may be desirable to provide a particular nutrient profile in the ultimate fertilizer end product.

In some embodiments, the conditioning step 22 is conducted at ambient temperature. In some embodiments, ambient temperature may vary depending on the location where the conditioning step 22 is conducted, but may be in the range of 2° C. to 35° C. or any value therebetween, e.g. in the range of 5° C., 10° C., 15° C. 20° C., 25° C. or 30° C. In some embodiments, the conditioning step is carried out at room temperature, e.g. in the range of 22° C. to 25° C. After the waste has been conditioned, further biological activity such as fermentation is essentially prevented and so the conditioned waste stream does not generate an appreciable amount of heat on its own.

Conditioning step 22 can be carried out for any suitable period of time to begin inactivating the bacteria and other biologically active agents in waste stream 21. In some embodiments, conditioning step 22 is carried out for at least about 16 to 24 hours. Conditioning step 22 can be carried out for longer periods of time if desired and, as described below, the conditioned waste stream can be stored indefinitely in the conditioned state.

In some embodiments, an optional storage step 23 is provided. In some embodiments, storage step 23 can be viewed as an extension or continuation of the conditioning step 22. The conditioned waste stream, for example, manure, can be stored for any desired length of time, for example between about 1 week and 1 year or more. In some embodiments, during storage step 23, the pH of the solution is periodically re-adjusted to maintain an acidic or alkaline pH (depending on the pH that was used for the conditioning step 22). Without being bound by theory, residual biological activity and bioactive agents may gradually shift the pH of the conditioned material over time during storage. The effects of such residual activity are expected to decrease over time during the storage of the conditioned manure.

In some embodiments, during storage step 23 the pH of the conditioned waste stream is periodically monitored, and the pH is adjusted to return the pH to a desired level (i.e. acidic or basic). In one example embodiment, the pH of conditioned manure is monitored every two weeks during storage step 23, and further acid or base is added to return the pH of the conditioned manure to a desired level, e.g. less than about 1.5 where the conditioning step was conducted at acidic pH, or about 12 to 13 where the conditioning step was conducted at basic pH. Similar periodic monitoring is conducted in other embodiments for other waste streams.

In another example embodiment, a pH monitor is provided in the storage tank where the conditioned waste stream is stored and the pH is periodically or continuously monitored. When the measured pH deviates by more than a predetermined amount from a desired level, e.g. by about more than a pH difference of about 0.5, further acid or base is added to return the pH of the conditioned waste stream to the desired level. In one example embodiment where conditioning step 22 is conducted at an acidic pH of approximately 1.5, during storage step 23 if the pH increases to about 2 or higher, further acid is added to return the pH of the conditioned waste stream to approximately 1.5. In another example embodiment where conditioning step 22 is conducted at a basic pH of approximately 12, during storage step 23 if the pH decreases to approximately 11.5 or below, further base is added to return the pH of the conditioned waste stream to approximately 12.

In some embodiments, storage step 23 can be conducted for any desired length of time. In some embodiments, it is desired to collect a large amount of waste, for example manure, before carrying out catalytic reaction step 24. In some embodiments, storage step 23 is conducted for a period of one week, two weeks, one month, two months, three months, six months, eight months, one year, or any period therebetween. In some embodiments, a waste stream input 21, for example manure from a farm, is collected at regular intervals, for example daily, and is subject to a conditioning step 22 and then is passed to storage step 23. The waste stream input 21 may be collected, conditioned and stored in this manner for a desired period of time before passing the stored conditioned waste stream to the catalytic reaction step 24.

It is observed that treatment of manure using acids and bases has been attempted, but presents a risk of foaming and potential hazards associated with the production of noxious gases. Adding acid to manure slurry can be particularly dangerous because this process can release a large volume of hydrogen sulfide gas, which can be deadly. Borst (2001) reported the death of 582 animals following abrupt acidification of a slurry pit with lactic acid, which resulted in massive release of hydrogen sulphide gas from the slurry.

In some embodiments, the waste stream 21 to be treated is freshly excreted manure, which has low levels of hydrogen sulfide and ammonia that present a risk of formation of noxious gases as aforesaid. In some embodiments, risks presented by the presence of residual levels of hydrogen sulfide in the waste stream, including in manure or in a manure slurry, are minimized by conducting the conditioning step 22 as a titration, which is a slow process. In some embodiments, the hydrogen peroxide added as part of catalytic reaction step 24 reacts with hydrogen sulfide to prevent release of hydrogen sulfide gas from the slurry.

The following equations discussed with reference to a manure slurry as an example waste stream illustrate the chemical basis for concluding that conducting the conditioning step 22 as a titration process or adding hydrogen peroxide minimizes the risks posed by any residual hydrogen sulfide that may be present in the waste stream, including in fresh manure, or to a more significant extent, in a manure slurry that has been stored for some period of time prior to conditioning.

In a manure slurry environment at a pH above 8.5, hydrogen sulfide is mostly present as sulfide ion S²⁻. Therefore as per the following equation:

S²⁻+2H₂O₂→SO₂²⁻+H₂O 21)

in the presence of hydrogen peroxide, sulfide ion is oxidized to sulfite.

In a manure slurry environment at pH below 8.5, hydrogen sulfide is mostly present as dissolved gas H₂S. Therefore as per the following equation:

H₂S+H₂O₂→S+2H₂O 22)

hydrogen sulfide is oxidized to elemental sulfur.

With respect to the effects of conditioning on residual ammonia that may be present in the waste stream, including for example in manure, or to a greater extent, in stored manure slurry, the following equations explain how acid or alkaline conditioning can prevent volatilisation of ammonia:

NH₃ (g)+HCl→NH₄Cl (aq) 23)

NH₄Cl (aq)+NaOH (aq)→NH₄OH (aq)+NaCl (aq) 24)

NH₄Cl (aq)+NaOH (aq)→NaCl (aq)+H₂O+NH₃ (g) 25)

NH₃ (g)+H₂O→NH₄OH (aq) 26)

Thus, in the case of acid conditioning, ammonia gas tends to be converted to ammonium chloride, which remains in solution. In the case of alkaline conditioning, ammonia tends to be converted to ammonium hydroxide, which remains in solution. Furthermore, a mixture of hydrogen peroxide and ammonium hydroxide (for example, in a 1:3 ratio) acts as a reactive oxidizer, which can further enhance breakdown of complex organic compounds present in manure and facilitate particulate matter degradation.

In some embodiments, the conditioning step is carried out at the site of collection of the waste stream, for example, on a farm where manure is collected from a livestock operation. Conducting the conditioning step at the time that or shortly after the waste stream is collected can reduce or eliminate the production of noxious gases and odors and/or greenhouse gases in or near the livestock operation. For example, many toxic gases such as ammonia and hydrogen sulfide are emitted as a result of microbial fermentation when raw manure slurry is stored. Carrying out the conditioning step halts such fermentation processes, and the production of any gaseous emissions associated with fermentation. Thus, in some embodiments, the atmosphere in or near the livestock operation can be improved.

In some embodiments, primary alkaline conditioning preserves organic and inorganic major elements such as carbon, nitrogen and phosphorous, as well as micronutrient elements such as calcium, magnesium, iron, cobalt, chromium, copper, iodine, manganese, selenium, zinc and molybdenum, naturally present in waste streams such as manure. Thus, in some embodiments, the resultant product of the treated waste stream has the beneficial attributes of a natural fertilizer (i.e. the presence of major elements and micronutrient elements present in a natural fertilizer such as manure), as well as being fortified with potash salts.

The catalytic reaction step 24 is now described in greater detail. The conditioned waste stream is combined with a transition metal catalyst and hydrogen peroxide to initiate the catalytic reaction step. In some embodiments, the transition metal catalyst is an iron-based nanoparticulate catalyst. In some embodiments, the iron-based nanoparticulate catalyst is as described in WO 2013/000074.

As outlined in WO 2013/000074, an iron-based nanoparticulate catalyst can be obtained by oxidizing a highly reduced solution of iron, such as groundwater that has not been exposed to oxygen. Upon oxidation, various elements in the water precipitate into nanoparticles or aggregates of nanoparticles, with a large population of nanoparticles or aggregates in the 50 to 200 nm range. The iron may be multivalent, i.e. possess more than one oxidation state, which may vary from zero to five. The core structure of the nanoparticulate catalyst can include calcium carbonate. As outlined in WO 2013/000074, the iron-based nanoparticulate catalyst increases the level of dissolved oxygen present in an aqueous catalytic reaction system containing hydrogen peroxide (H₂O₂).

In some embodiments, the iron-based nanoparticulate catalyst added to the reaction mixture is in the form of a stock solution comprising a slurry of a 1:1 mixture of solid iron-based nanoparticulate catalyst and water having a concentration in the range of 1.0 to 1.5 mg/mL iron-based nanoparticulate catalyst, and the amount of this slurry added to the waste stream is in the range of 0.15% to 1.5% v/v, or any value therebetween, e.g. 0.25%, 0.50%, 0.75%, 1.0% or 1.25% v/v. In some embodiments, the amount of iron-based nanoparticulate catalyst stock solution added to the waste stream is approximately 1.0% v/v.

In some embodiments, the amount of hydrogen peroxide added at catalytic reaction step 24 is in the range of about 0.35% to 1% v/v, or any value therebetween, e.g. 0.4%, 0.5%, 0.6%, 0.7%, 0.8% or 0.9%. In some embodiments, higher concentrations of hydrogen peroxide may be used, e.g. up to 15%, although higher concentrations may be less desirable from the view of conducting an economically efficient waste treatment process and may cause the chemical reactions to proceed too quickly for the operation of a safe process. In some embodiments, the catalytic reaction step 24 is carried out in plastic containers to avoid damage that might be caused to concrete or steel reaction containers by the use of hydrogen peroxide.

In some embodiments, the catalytic reaction step 24 is conducted at an acidic pH, e.g. a pH in the range of about 2.5 to 4.5. In some embodiments, the acidic pH is achieved by adding a polyvalent carboxylic acid to the biomass. In some embodiments, the polyvalent acid is citric acid, ascorbic acid, oxalic acid, malic acid or aconitic acid. In some embodiments, the catalytic reaction step 24 includes a step conducted at an alkaline pH, e.g. a pH of above 8, a pH in the range of 11 to 14, or a pH in the range of 12 to 13, for example as described with reference to process 200 described below. In some such embodiments, the pH of the solution is first reduced to an acidic pH, e.g. a pH in the range of about 2.5 to 4.5, by the addition of a suitable polyvalent carboxylic acid. The transition metal catalyst and hydrogen peroxide are then added and incubated for a short time, e.g. 30 minutes at room temperature, to jump-start the catalytic reaction, and the pH of the reaction solution is then increased to the desired alkaline pH, which is a pH in the range of 12 to 13 in some example embodiments, using a suitable base, for example NaOH, KOH or NH₄OH. In some such embodiments, the alkaline catalytic reaction step is followed by a further catalytic reaction step conducted at acidic pH.

In some embodiments, catalytic reaction step 24 is conducted at ambient temperature, e.g. any temperature in the range of 0° C. to 40° C. or any value therebetween, e.g. 5 ° C., 10° C., 15 ° C., 20° C., 25° C., 30° C. or 35° C. In some embodiments, catalytic reaction step 24 is conducted at above ambient temperature. In some embodiments, catalytic reaction step 24 is conducted at any temperature between about 15° C. and about 95° C. or any value therebetween, e.g. 20° C., 30° C., 40° C., 50° C., 60° C., 70° C., 80° C. or 90° C. In some embodiments, the catalytic degradation step is conducted in the range of about 50° C. to about 95° C.

In some embodiments, the catalytic reaction step 24 is conducted at above atmospheric pressure. In some embodiments, the catalytic reaction step 24 is conducted at a pressure in the range of 10 psi to 100 psi above atmospheric, or any value therebetween, e.g. 20, 30, 40, 50, 60, 70, 80 or 90 psi above atmospheric. In some embodiments, the catalytic reaction step 24 is conducted at a pressure of 40 psi above atmospheric.

Conducting the catalytic reaction step 24 at a higher temperature may increase the speed of the reactions that drive the breakdown of complex polymers and organic molecules during the reaction. Generally, the temperature at which catalytic reaction step 24 is conducted will be inversely proportional to the duration of catalytic reaction step 24, i.e. the higher the temperature, the shorter the necessary processing time. In some embodiments where catalytic reaction step 24 is conducted at above ambient temperature, the catalytic reaction step 24 is conducted for a period of time of between 1 hour and 24 hours or any value therebetween, e.g. 2, 3, 4, 5, 6, 7, 8, 9, 10, 11, 12, 13, 14, 15, 16, 17, 18, 19, 20, 21, 22 or 23 hours, or longer if desired. In some embodiments where the catalytic reaction step 24 is conducted at ambient temperature, the step is conducted for a longer period of time, e.g. several days (e.g. 2, 3, 4, 5, 6 or 7 days) in embodiments where the catalytic reaction step 24 is conducted at approximately room temperature or higher (e.g. in the range of about 17° C. to 25° C. or higher), or longer, e.g. several weeks or months (e.g. 1, 2, 3, 4, 5 or 6 weeks, or 1, 2, 3, 4, or 5 months) in embodiments where the catalytic reaction step 24 is conducted at ambient temperatures lower than room temperature (e.g. in the range of about 2° C. to about 10° C.).

In some embodiments, the determination of whether to conduct catalytic reaction step 24 at a temperature above ambient temperature is made based on the availability of storage space for conducting conditioning step 22. For example, in embodiments where there is limited space for conducting conditioning step 22 or storage step 23, it may be desirable to conduct catalytic reaction step 24 at elevated temperature for a shorter time period. In embodiments where there is sufficient or ample space for conducting conditioning step 22 or storage step 23, it may be more efficient to conduct catalytic reaction step 24 at ambient temperature for a longer time period.

In some embodiments, the catalytic reaction step 24 breaks down contaminants in waste stream 21. In some embodiments, the catalytic reaction step breaks down contaminants such as heterocyclic aromatic molecules, genetic material (including DNA, RNA, plasmids or the like), antibiotics, hormones, pesticides, and/or drugs that may be present in waste stream 21 where waste stream 21 is of biological origin, e.g. animal manure or municipal sewage effluent. In some embodiments, the catalytic reaction step 24 breaks down environmental toxins, for example, phenol, nonylphenols, phthalates, bisphenol A, polycyclic aromatic hydrocarbons, and the like. In some embodiments, organic molecules comprising aromatic rings are broken down to linear chains. In some embodiments, toxins such as dioxins, PCBs, polycyclic aromatic hydrocarbons, and the products of plastic breakdown can be broken down at catalytic reaction step 24 to treat an industrial waste stream. Some embodiments of the invention may have application in the treatment of various industrial waste streams and effluents, including potentially in the treatment of waste produced in obtaining oil from tar or oil sands.

Also during catalytic reaction step 24, complex carbohydrates are broken down through reaction with reactive oxygen species and by hydrolysis, as outlined above. Thus, waste stream 21 is broken down both physically (i.e. to a smaller size of particulate matter) and chemically.

The treated waste product is harvested at step 26. The treated waste product can be harvested in any appropriate manner. In some embodiments, the treated waste product obtained at step 26 is applied directly in the field as a liquid (for example in agricultural, horticultural or landscaping applications). In some embodiments, the resultant product is dewatered, for example using a screen, centrifugation, a clarifier, a screw press, or the like, and applied in the field (for example in agricultural or landscaping applications) in granular form.

In some embodiments, the resultant product of the treated waste stream is sterile or nearly sterile, thereby avoiding disadvantages traditionally associated with the use of manure-based fertilizers, for example, contamination of produce with pathogens such as Salmonella or E. coli. In some embodiments, the resultant product of the treated waste stream is therefore useful in organic farming where the use of manure-based fertilizer is desirable.

In some embodiments, the resultant product of the treated waste stream has little or no perceptible odor. Thus, in some embodiments, the resultant product can be used as a fertilizer in agricultural, horticultural or landscape applications even in the immediate vicinity of inhabited areas where the use of more odorous fertilizer products might cause people nearby to be uncomfortable and/or complain about the use of fertilizer.

In some embodiments, the resultant product of the treated waste stream contains no or a very low concentration of environmental toxins such as phenol, antibiotics, pesticides, genetic material, hormones and/or other drugs or bioactive compounds.

In some embodiments, useful products can be produced from the products of catalytic degradation of the waste stream. For example, native lignin and technical quality crystalline cellulose are valuable products that can be obtained from the treatment of a waste stream such as manure or other agricultural or forestry wastes in some embodiments. Also, in some embodiments, a wide range of platform chemicals can be obtained from the treatment of a waste stream, including manure or other agricultural or forestry wastes. Thus, in some embodiments, valuable products can be generated through the treatment of a waste stream.

Based on preliminary experiments conducted by the inventors, it is estimated that in some embodiments, approximately 500 to 600 kg of native lignin, and 100 to 200 kg of crystalline cellulose, can be generated from 1000 kg of dairy cattle manure (based on dry matter, DM). Based on very conservative estimates using current prices of lignin ($1500/ton) and crystalline cellulose ($4000/ton), it can be reasonably predicted that in some embodiments, processing of a waste stream may yield a net profit in excess of $1000/ton of processed manure. In some embodiments, the material remaining following the recovery of commercially valuable compounds such as lignin, hemicellulose, cellulose, crystalline cellulose, and various platform chemicals from the waste stream, can be used as fertilizer as outlined above.

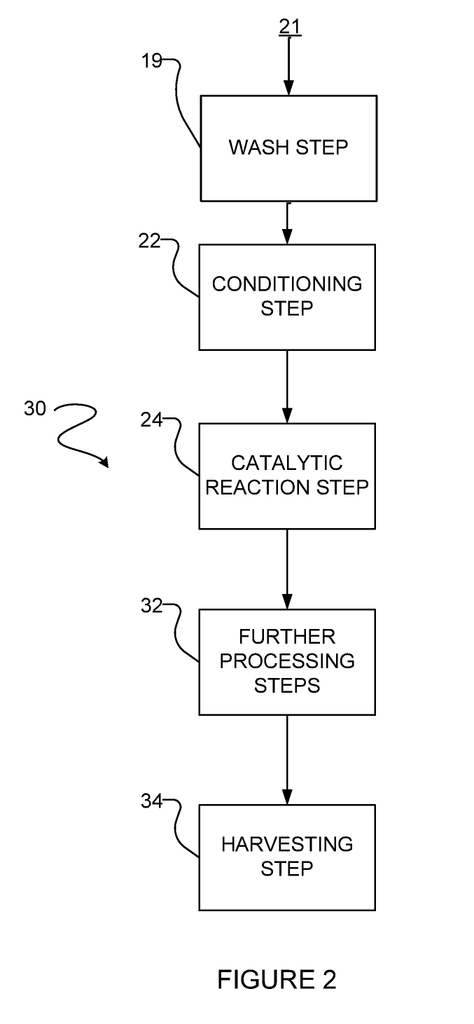

With reference to FIG. 2, the general steps of an embodiment 30 of a process for producing useful products from a waste stream is shown. Steps that are the same in process 30 as in process 20 are given the same reference number. A waste stream 21 is provided to a wash step 19 if needed, and then to a conditioning step 22 and conditioned by being subjected to acidic or basic conditions as described above. The conditioned waste stream is then subjected to a catalytic reaction step 24 as described above, optionally after a storage step. The treated waste stream is then subjected to a series of parallel and serial further processing steps at 32, as outlined in greater detail below. After the completion of the further processing steps 32, the resultant products are harvested at step 34. One of the products resulting from further processing steps 32 is the bulk of the biological matter remaining from the treated waste stream, which is useful as a fertilizer in the same manner as the product of method 20. Examples of further processing steps 32 include extraction, separation, purification and harvesting of specific compounds, as described in greater detail below.

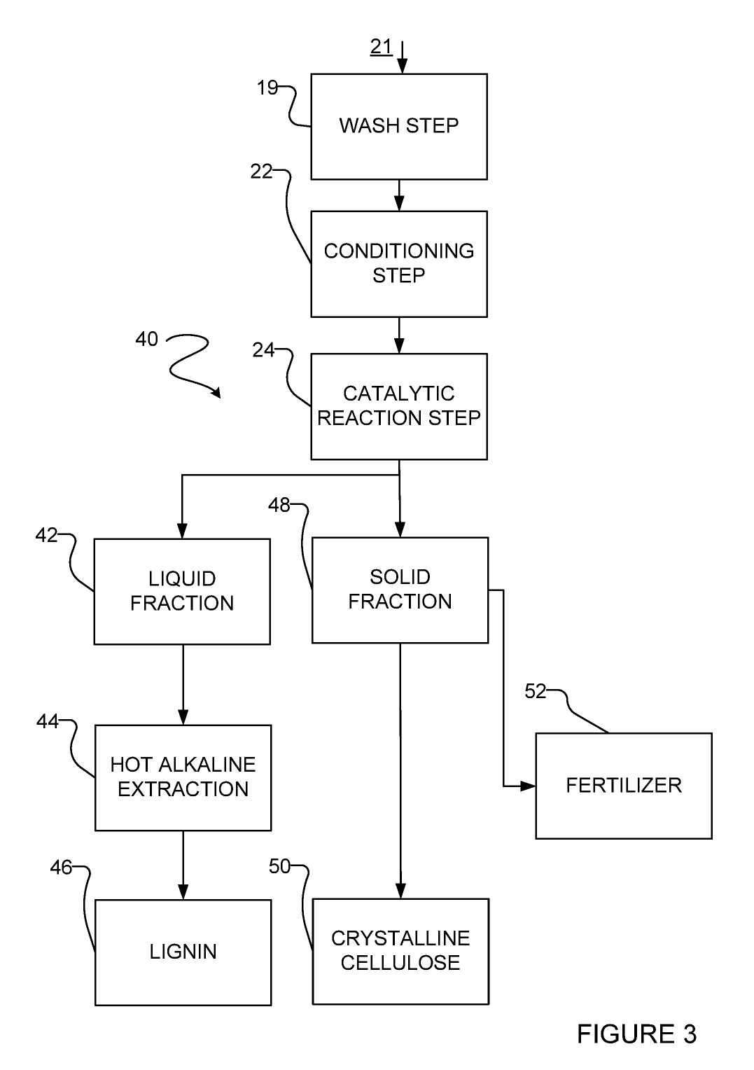

With reference to FIG. 3, an example embodiment of a waste treatment process 40 in which the valuable products lignin and crystalline cellulose are recovered from a waste stream, for example manure or lignocellulosic agricultural or forestry waste, is illustrated. Process steps which are the same in process 40 as in process 20 are labeled with the same reference numeral and are not described again.

In some embodiments, following catalytic reaction step 24, lignin remains in the liquid fraction 42 while crystalline cellulose separates into a solid fraction 48 as described in WO 2013/000074. In some embodiments, lignin is obtained in a hot alkaline extraction 44 after catalytic reaction step 24 that includes titrating the liquid fraction of the treated waste stream to an alkaline pH (if the waste stream is not already at alkaline pH following catalytic reaction step 24), e.g. a pH of between about 12 and 14, and subjecting the waste stream to hot alkaline extraction at high temperature, e.g. between 80° C. and 100° C. or any value therebetween, e.g. 85° C., 90° C. or 95° C. In some embodiments, the hot alkaline extraction is conducted for at least about 12 hours, for example 24 hours, and lignin is harvested at 46. In some embodiments, lignin is collected at 46 by passing the processed material through a paper filter to recover the filtrate containing lignin. In some embodiments, the filtrate is dewatered by evaporation to produce dry lignin.

In some embodiments in which it is desired to obtain lignin from a waste stream input such as manure or lignocellulosic agricultural or forestry biomass, conditioning step 22 is conducted at alkaline pH to facilitate subsequent alkaline extraction of lignin.

As described above and with reference to FIG. 3, in some embodiments, following catalytic reaction step 24, lignin from a waste stream 21 that includes biomass remains in the liquid fraction while crystalline cellulose separates into a solid fraction as described in WO 2013/000074. In some embodiments, crystalline cellulose 50 is recovered from the solid fraction 48 remaining after catalytic reaction step 24. As described in WO 2013/000074, in some embodiments, the solid crystalline cellulose fraction includes both a heavy fraction of microcrystalline cellulose and a lighter fraction of nanocrystalline cellulose. In some embodiments, crystalline cellulose 50 is recovered from solid fraction 48 by microfiltration, ultrafiltration or nanofiltration. The remainder of the treated waste stream 52 can be used for fertilizer, as described for processes 20 and 30.

In some embodiments in which the waste stream to be treated is manure and bedding (e.g. straw, wood chips, sawdust, shredded paper or the like), is present in waste stream 21, a greater proportion of crystalline cellulose can be recovered from the waste stream using a process as described in WO 2013/000074 or as above than in embodiments in which waste stream 21 comprises only manure.

It is also anticipated that other useful platform chemicals can be obtained from a waste stream such as manure or lignocellulosic agricultural or forestry waste by subjecting the waste stream to appropriate extraction conditions to recover such compounds. For example, manure may be rich in phenolic acids such as coumaric acid and salicylic acid, and other aromatic compounds such as vanillin and the like. Lignocellulosic agricultural waste may be a rich source for generating aromatic hydrocarbons, such as benzene, toluene and xylene, carboxylic acids, vanillin, vanilic acid, and aldehydes, amongst others (Holladay et al., 2007). Other types of lignocellulosic waste may have specific compounds present depending on the nature of the waste; for example, pulp produced from juice processing may contain compounds such as water soluble vitamins (e.g. vitamin C) and organic acids (e.g. citrate), phenolic acids, sugars and the like.

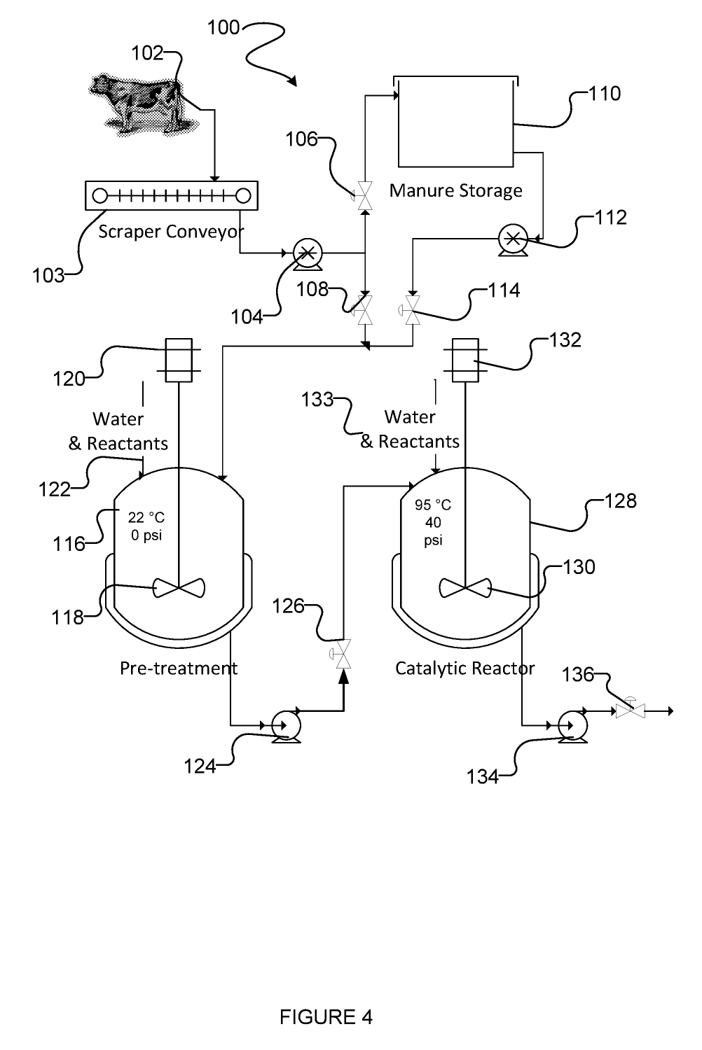

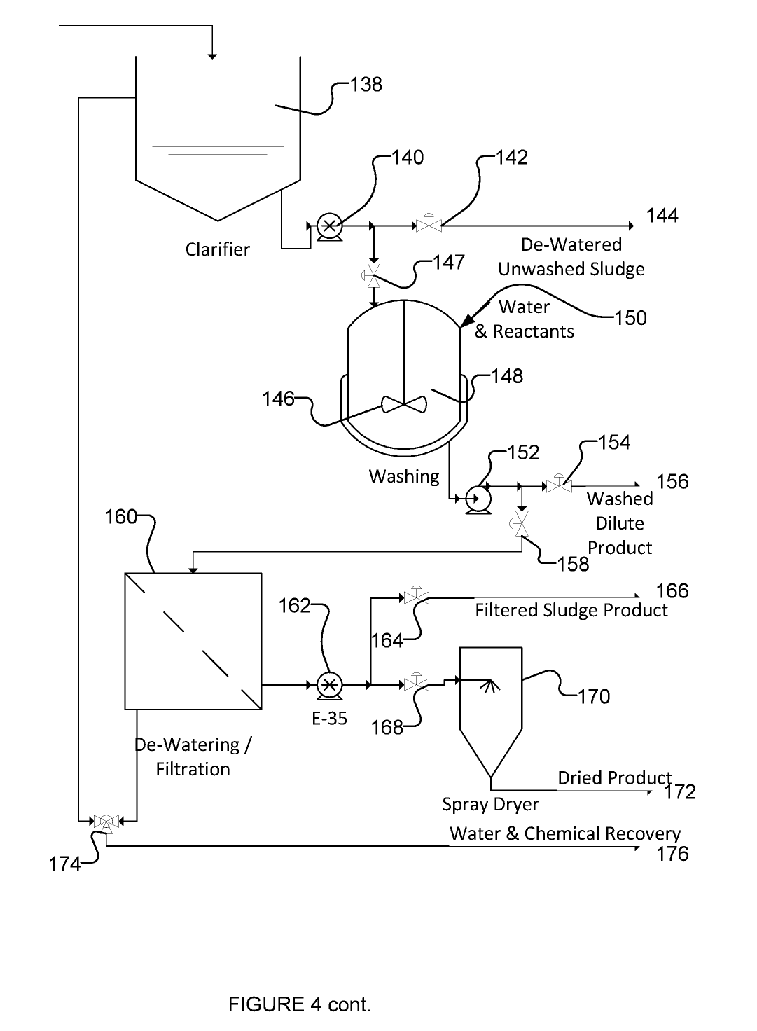

With reference to FIG. 4, the structure of a manure processing module 100 according to one example embodiment is illustrated. Depending on the desired objectives, the manure processing module can be directed towards production of fertilizer for the safe treatment and application of a waste stream such as manure as a value-added fertilizer, or the manure processing module can be directed towards the production of high value components such as lignin, crystalline cellulose and/or platform chemicals, with production of a value-added fertilizer from the waste material that remains after extraction of any desired valuable components.

Manure 102 obtained from a barn, for example a dairy cattle barn, is collected in any appropriate manner, for example using a scraper or conveyor 103. A pump 104 is provided to pump manure 102. In some embodiments, manure 102 is pumped to a manure storage tank 110. In some embodiments, manure 102 is pumped directly to a conditioning tank 116. A pair of valves 106, 108 control the flow of manure pumped by pump 104 to either manure storage tank 110 or conditioning tank 116, respectively. A pump 112 is provided to pump manure 102 from manure storage tank 110 to conditioning tank 116 via a valve 114.

In some embodiments, the manure is obtained from the barn in the form of a slurry (for example, in agricultural operations where manure is removed from the barn by washing with water). In some embodiments, the manure is combined with additional water 122 to form a slurry of a desired consistency in the manure storage tank or in conditioning tank 116 as in the illustrated embodiment. In some embodiments, the manure can be stored without addition of water, and water is added to form a manure slurry prior to passing the manure to further steps in the treatment process.

Conditioning tank 116 includes an impeller 118 powered by a motor 120, or other mechanism for mixing material provided to conditioning tank 116. Conditioning tank 116 is supplied with an appropriate acid or base 122 from an acid/base storage tank, and the acid or base is added to the manure slurry to decrease the pH of the manure slurry to less than 1.5 (in embodiments where an acid is added), or to increase the pH to a range of 12 to 13 (in embodiments where a base is added). In some embodiments, conditioning of manure in conditioning tank 116 is conducted at approximately room temperature (e.g. in the range of 20° C. to 25° C., e.g. 22° C.) and at atmospheric pressure (i.e. with a gauge pressure of 0 psi).

After the manure slurry has been conditioned in conditioning tank 116, the conditioned manure slurry is pumped via pump 124 and valve 126 to a catalytic reaction tank 128. The catalytic reaction tank 128 includes an impeller 130 powered by a motor 132 or other mechanism for mixing material provided to the catalytic reaction tank. Appropriate amounts of transition metal catalyst, which is an iron-based nanoparticulate catalyst in some embodiments, and hydrogen peroxide 133 are added to initiate catalytic treatment of the conditioned manure slurry.

In some embodiments, catalytic treatment of the conditioned manure slurry is carried out at a temperature in the range of 80° C. to 100° C., e.g. 95° C., and at a pressure above atmospheric, e.g. 30-50 psi, e.g. 40 psi gauge pressure. A pump 134 and valve 136 are provided for controlling the flow of treated manure slurry out of catalytic reaction tank 128.

In some embodiments where the primary objective of the treatment of the manure is the provision of a fertilizer product, following catalytic treatment of the manure slurry in catalytic reaction tank 128, the desired fertilizer product is obtained. In some embodiments where it is desired to apply the fertilizer in a liquid form, e.g. for agricultural or landscape applications, the treated manure slurry is pumped directly onto a desired location as a fertilizer. In some embodiments where it is desired to apply the fertilizer in a solid form, the solid fraction is separated and dewatered in any suitable manner. For example, in the illustrated embodiment the treated manure slurry is pumped to a clarifier 138 via pump 134 and valve 136. The solid fraction can be pumped as a sludge from clarifier 138 by pump 140 and passed through valve 142 to provide a de-watered unwashed sludge potentially suitable for application as a fertilizer at 144.

Alternatively, the solid fraction can be pumped to a washing tank 148 via valve 147. In washing tank 148, an impeller 146 can be used to agitate the solid fraction with water and any additional desired reactants 150. Pump 152 can be used to pump the liquid product from washing tank 148 through valve 154 to provide a washed dilute fertilizer product at 156, or via valve 158 for de-watering or filtration in any suitable manner at 160, for example using a clarifier, screw press, centrifuge or screen. The solid fraction so obtained can be pumped via pump 162 via valve 164 to provide a filtered sludge product 166. In some embodiments, filtered sludge product 166 could be applied to a desired location as a fertilizer, e.g. for an agricultural or landscape application. Alternatively, in some embodiments, the solid fraction can be pumped via pump 162 and valve 168 to a spray dryer 170, where it is dried to provide a dried product 172 that can be used as a fertilizer in any desired location. The liquid fraction obtained at de-watering/filtration station 160 and/or the liquid fraction obtained from clarifier 138 can be passed via valve 174 for water and chemical recovery at 176.

In some embodiments where it is desired to isolate high value components from the manure, following catalytic treatment of the manure slurry, further processing may be conducted to obtain the desired products from the manure. In some embodiments, crystalline cellulose is recovered from the solid fraction recovered from clarifier 138. In some embodiments, lignin is recovered from the liquid fraction recovered from clarifier 138 using a hot alkaline extraction process. In some embodiments, various platform chemicals may be recovered by using appropriate product recovery steps.

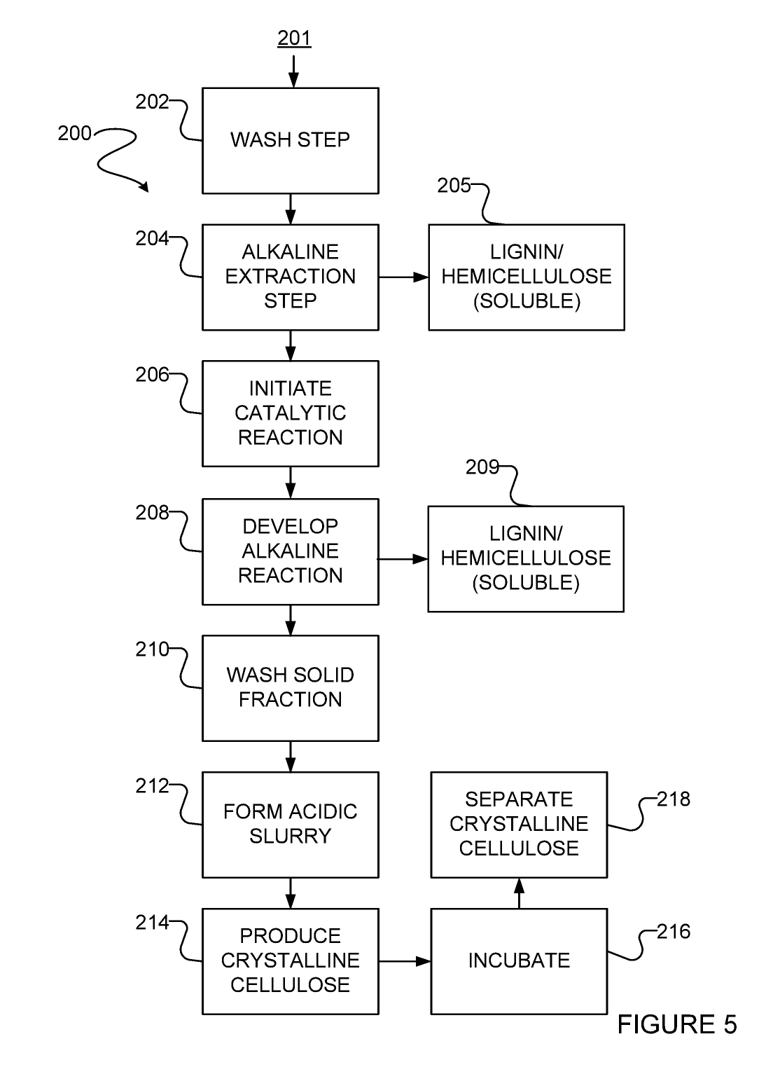

FIG. 5 illustrates an example embodiment of a process 200 for obtaining desirable bioproducts from lignocellulosic biomass using a catalytic reaction step conducted at alkaline pH. The inventors have found that conducting a catalytic reaction step at alkaline pH allows for the recovery of bioproducts including crystalline cellulose from recalcitrant biomasses without the need for a harsh pre-treatment step, for example using performic acid, and may allow for the recovery of crystalline cellulose of higher quality than can be obtained if the catalytic reaction step is conducted only at acidic pH.

While process 200 is described with reference to manure as an exemplary lignocellulosic biomass and includes exemplary treatment conditions that have been optimized for the processing of lignocellulosic biomass from manure, the same procedures, with some optimization for the requirements of each different type of biomass, can be used on any form of biomass, including recalcitrant biomass. For example, in some embodiments, the biomass is an agricultural or forestry waste stream such as woody material, including wood chips, wood waste, sawdust, wood pulp, pulping byproducts, cereal grain straw, hemp straw, flax straw, shives or hurd from flax or hemp, hulls including oat hulls or rice hulls, cotton gin waste, or various chaff, grass including Miscanthus (elephant grass), corn stover, corn husks, or sugarcane bagasse. In some embodiments, the biomass is any form of lignocellulosic biomass, for example, plant parts, fruits, vegetables, hemp, grasses, oats, rice, corn, weeds, aquatic plants, hay, forestry products or byproducts, wood chips, sawdust, wood waste, wood pulp, pulping byproducts, paper, paper products, paper waste or peat. In some embodiments, the biomass is a recalcitrant biomass, for example straw or wood are known to be recalcitrant to biorefining and to have a relatively higher lignin content than other biomass. In some embodiments, the biomass is a combination of different biomasses, for example, manure and a bedding material such as straw, wood chips, paper, hay, grass or the like.

At step 202, biomass material is thoroughly washed to remove the bulk of undesired contaminants from the lignocellulosic material, although this step could be omitted in some embodiments. In some embodiments, if necessary or desired, the biomass material is subjected to a conditioning step and/or a storage step under acidic or alkaline conditions as described above.

At step 204, the washed biomass is pre-treated in water adjusted to an alkaline pH, for example a pH of approximately 12, to facilitate extraction of available lignin, hemicellulose, and other water soluble compounds, leaving cellulose in the solid fraction. In some embodiments, the water is adjusted to pH 12 using a solution of a suitable base, for example 50% (v/v) NaOH, KOH or NH₄OH. In some embodiments, step 204 is conducted at ambient temperature, for example, room temperature, ambient temperature, or any temperature greater than about 10° C. In some embodiments, step 204 is conducted at elevated temperatures, e.g. in the range of 60° C. to 95° C., or any value therebetween e.g. 65, 70, 75, 80, 85 or 90° C., to enhance the efficiency of removal of available lignin and hemicellulose by hot alkaline extraction, as described above with reference to process 40. In some embodiments, a higher processing temperature is used to improve the recovery of lignin and/or hemicellulose, if this is economically justified, for example, a temperature of between 100 and 160° C. or any value therebetween, e.g. 105, 110, 115, 120, 125, 130, 135, 140, 145, 150 or 155 ° C. The treatment period for step 204 can be determined by one skilled in the art based on the biomass being processed and the process conditions selected. In some example embodiments, the treatment period for step 204 is between 30 minutes and 10 hours, or any time therebetween, e.g. 1, 2, 3, 4, 5, 6, 7, 8 or 9 hours. Recovered lignin and hemicellulose are removed in the aqueous fraction at step 205.

At step 206, the solid fraction of the biomass is washed with water until it is neutral, and is then dispersed in an acidic solution (i.e. a solution having a pH below 7) to form a slurry. In some embodiments, the acid used to reduce the pH of the slurry is a polyvalent carboxylic acid, such as citrate, ascorbate, oxalate, or aconitate. In some embodiments, the pH is reduced to approximately 2.5 to 4.5 or any value therebetween, e.g. 3, 3.5 or 4. In some embodiments, the pH of the resultant solution is adjusted using an aqueous solution saturated with citrate having a pH in the range of 3.2 to 3.5. In some embodiments, the slurry produced has a concentration in the range of about 2.5 to 5% (w/v) of solid biomass material, or any value therebetween, e.g. 3%, 3.5%, 4% or 4.5% (w/v). Any suitable concentration of solid biomass material can be used.

Trace amounts of a transition metal catalyst, which is an iron-based nanoparticulate catalyst in some embodiments, are added and thoroughly mixed into the slurry. In some embodiments, the trace amount of iron-based nanoparticulate catalyst is an amount of between about 0.001% and 1% (w/v), or any value therebetween, e.g. 0.005%, 0.01%, 0.05%, 0.1%, 0.2%, 0.4%, 0.6%, or 0.8% (w/v). The amount of transition metal or iron-based nanoparticulate catalyst to be added may vary depending on the natural transition metal ion content of any particular biomass to be treated, with less catalyst being required for those biomasses that have a higher content of transition metals. The inventors have found that addition of an iron-based nanoparticulate catalyst at a concentration of about 0.1% (w/v) produces good results, with somewhat lower efficiencies being obtained if more or less iron-based nanoparticulate catalyst is used. However, the optimal amount of catalyst to be used may vary somewhat depending on the particular biomass to be treated, and optimization of the amount of catalyst used would be expected to be within the ordinary ability of one skilled in the art.

This preparation is conditioned for a suitable period of time in some embodiments, which is approximately 5 to 30 minutes at room temperature in one example embodiment, to allow good impregnation of the biomass fiber with polyvalent carboxylic acid ions and iron-based nano-particulate catalyst, and then hydrogen peroxide (35% stock) is added to a final concentration of approximately 0.35% v/v in one example embodiment, although any suitable concentration can be used, for example between 0.1% to 1% v/v or higher. Following this the reaction is allowed to develop for a suitable time period, which is approximately 5 to 30 minutes at room temperature in one example embodiment, or any time therebetween e.g. 10, 15, 20 or 25 minutes, although any suitable time and temperature can be used, and the slurry is titrated with 50% NaOH (or other suitable base, e.g. KOH or NH₄OH) to obtain a final pH of approximately 12. In some embodiments, the final pH is between about 11 and about 13. In some embodiments, the final pH is any alkaline pH, for example a pH in the range of 8.5 to 14, or any value therebetween, e.g. 9, 9.5, 10, 10.5, 11, 11.5, 12, 12.5, 13, or 13.5. This step can be described as an alkaline catalytic reaction step.

The alkaline catalytic reaction is allowed to develop at step 208. In some embodiments, step 208 is conducted at an elevated temperature, i.e. any temperature higher than room temperature. In some embodiments, step 208 is conducted at a temperature in the range of 10° C. to 160° C. or any temperature therebetween, e.g. 20, 30, 40, 50, 60, 70, 80, 90, 100, 110, 120, 130, 140 or 150° C. In one example embodiment, step 208 is conducted at a temperature of approximately 80° C. In another example embodiment, step 208 is conducted at a temperature in the range of 95-100° C. In other embodiments, the processing temperature can be higher (e.g. in the range of 100° C. to 160° C.), if economically justified by the particular biomass being processed and the desired end product. In one example embodiment, the reaction mixture is incubated on a hot plate with constant stirring. Step 208 is carried out for a desired period of time, which may vary depending on the nature of the biomass being processed and the temperature. In typical embodiments, step 208 is carried out for several hours, e.g. between 4 and 10 hours or any value therebetween, e.g. 5, 6, 7, 8 or 9 hours, and may be repeated as required to optimize yield of desired products.

After step 208 is complete, additional lignin and hemicellulose are optionally removed in the soluble fraction at step 209, and the insoluble fraction of the slurry is optionally washed with running water at step 210 to remove soluble contaminants. Without being bound by theory, it is believed that the solid fraction obtained after the alkaline catalytic reaction step comprises relatively pure cellulose (including some crystalline cellulose), which can then be further treated to obtain a desired crystalline cellulose bioproduct of relatively high purity as described below. Alternatively, if the desired bioproduct is cellulose, the cellulose product can be recovered from the solid fraction at step 210.

The extracted biomass material is then placed in distilled water at step 212 to form a slurry having a suitable concentration, for example in the range of approximately 1% to 10% w/v or any value therebetween, e.g. 2, 3, 4, 5, 6, 7, 8 or 9%, and which is approximately 5% w/v in some example embodiments, and is thoroughly mixed to provide a uniform slurry. This slurry is titrated with citrate or other suitable polyvalent organic acid, for example ascorbate, oxalate or aconitate to obtain a desired acidic pH level, for example between 2.5 and 4.5 or any value therebetween e.g. 3, 3.5 or 4, or between 3.5 and 3.8 in some example embodiments. In some embodiments, the solution of polyvalent organic acid used to conduct the titration is a saturated solution. The resultant solution is again thoroughly mixed and incubated at room temperature for a few minutes. The pH is checked, and re-adjusted if required.

At step 214, crystalline cellulose is produced. While crystalline cellulose can be recovered without conducting step 214 in some embodiments, conducting step 214 improves the yield of crystalline cellulose. A transition metal catalyst, which is an iron-based nanoparticulate catalyst in some embodiments, is added from a stock to a final concentration of approximately 1% (w/v), and hydrogen peroxide is added from a 35% stock to a final concentration of approximately 0.35% v/v (although any suitable concentration can be used as described with reference to catalytic reaction step 24 above, e.g. 0.1% to 1% v/v) and mixed thoroughly. This preparation is incubated at room temperature for a few minutes. The pH is checked and adjusted if required to return it to the desired level, which is an acidic pH, for example in the range of 2.5 to 5 or any value therebetween, e.g. 3, 3.5, 4 or 4.5, including a pH of between 3.5 and 3.8 in one example embodiment. At this point, in one example embodiment, the mixture shows an oxidation-reduction potential (ORP) relative to water of between 140-180 mV.

At step 216, the complete reaction mixture is incubated at a desired temperature for a desired treatment period, which is 4 to 10 hours in some example embodiments, or any period of time therebetween, e.g. 5, 6, 7, 8 or 9 hours. In some embodiments, the desired temperature is in the range of 10° C. to 160° C., or any temperature therebetween, e.g. 20, 30, 40, 50, 60, 70, 80, 90, 100, 110, 120, 130, 140 or 150° C. In one example embodiment, the complete reaction mixture is incubated on a hot plate at approximately 80° C.-95° C. with constant stirring during this treatment period.

At step 218, crystalline cellulose is separated from the reaction mixture as the solid fraction using any suitable method, for example, filtration, centrifugation, spray drying, or the like. In some embodiments, nanocrystalline cellulose is present in the soluble fraction, and can be recovered by any suitable method, for example using a suitable nanofilter.

### EXAMPLES

Example embodiments of the invention are further described with reference to the following examples, which are intended to be illustrative and not limiting in nature.

### Example 1.0

### Materials and Methods

A series of bench top experiments was conducted to assess the effectiveness of conditioning a waste stream using various acids and bases to halt microbial fermentation. All experiments were conducted using manure samples collected from the University of

Saskatchewan dairy barn. The research material was collected directly from the storage pit or from the floor. The basal stock of manure slurry so obtained was first mixed with RO (reverse osmosis) water (1:1 vol/vol). The diluted manure slurry aliquots (100 mL) were distributed in glass flasks.

The iron-based nanoparticulate catalyst was prepared as described in WO 2013/000074 using natural well water containing 10 ppm of iron having the composition set forth in Table 1. The water when freshly pumped from the well is crystal clear, but when exposed to air or oxidizing chemicals (e.g. chlorine based water disinfection products), it becomes murky due to oxidation of iron.

TABLE 1
Composition of natural well water used to prepare iron-based
nanoparticulate catalyst.

| Basic Livestock Suitability | | | |
|---|---|---|---|
| Iron (Fe)-Extractable | 10.1 | 0.005 | mg/L |
| Chloride (Cl) | 7 | 1 | mg/L |
| Nitrate | <1 | 1 | mg/L |
| pH and Conductivity | | | |
| TDS (Calculated from EC) | 1660 | 1 | mg/L |
| pH | 7.2 | 0.1 | pH |
| Conductivity (EC) | 2600 | 0.2 | uS/cm |
| ICP Cations and Hardness | | | |
| Calcium (Ca) | 357 | 1 | mg/L |
| Potassium (K) | 12 | 1 | mg/L |
| Magnesium (Mg) | 180 | 1 | mg/L |
| Sodium (Na) | 79 | 1 | mg/L |
| Sulfate (SO4) | 1190 | 0.5 | mg/L |
| SAR | 0.9 | 0.1 | SAR |
| Hardness (CaCO3 equivalent) | 1630 | 1 | mg/L |

When reduced iron in well water in its native configuration is exposed to oxidizing agents, as the process of oxidation progresses, oxidized iron eventually precipitates as very fine deposits. An abundance of particles in the 50 to 200 nm range is observed. Based on X-ray diffraction analyses, it appears that the vast majority of the nanoparticle is calcite (CaCO₃), and iron forms a thin coating on the calcite/clay core. Most of the iron is in the Fe³⁺ valence by the time the nanoparticles are observed.

To rapidly and efficiently precipitate the iron-based nanoparticulate catalyst, 12% chlorine-based commercial disinfection product is added to well water at a rate of 1 mL per litre. The mixture is agitated very vigorously, and a very fine suspension of iron particles forms immediately. The formation of this initial suspension marks the commencement of the nucleation process of the nano-particles. This preparation is allowed to mature undisturbed to complete the nucleation of nano-particles (usually in the range of 60 minutes).

Following the completion of nucleation process, very fine dark red/brownish particles start to precipitate on the bottom of the container under gravity. Typically after 2 to 3 hours, the catalyst enriched bottom layer can be harvested. The harvested sediment is filtered through a fine stainless steel mesh filter, and washed several times in water purified by reverse osmosis until residual chlorine is removed. The resultant iron-based nanoparticulate catalyst product readily separates from water under gravity, forming a clear layer of water on top, and dark red/brownish sediment comprising iron nano-particles on the bottom. A stock solution of the iron-based nanoparticulate catalyst was prepared by adding a volume of water equivalent to the volume of precipitated catalyst (i.e. 1:1 v/v) and forming a slurry to provide an iron-based nanoparticulate catalyst stock solution.

The initial set of experiments conducted in small volume (100 mL) glass vessels was followed by an experiment in larger reaction vessels. The larger scale tests were conducted in glass beakers (reaction volumes 1000 and 2000 mL), stainless steel containers (reaction volume 2 L), and plastic containers (reaction volumes ranging 2.5 to 10 L).

To assess odor, the manure samples were subjected to sensory evaluation by independent observers (persons not associated with this study and representative of local community) to evaluate smell of samples presented in random order. None of the evaluators was aware of sample identity.

### Example 2.0

### Preliminary Characterization of Manure Slurry Samples

### Example 2.1

### Baseline Properties of Untreated Manure Slurry Samples

The 100 mL manure slurry aliquots obtained as described in Example 1.0 were subjected to initial physico-chemical evaluation to determine parameters such as pH, oxidation-reduction potential (ORP), and dissolved oxygen (DO) content.

Evaluation of raw manure collected from the pit revealed the following physico-chemical and sensory characteristics: pH was between 6.0 and 6.6, oxidation-reduction potential (ORP) (relative to reverse osmosis water) was approximately between −550 and −650 mV, dissolved oxygen was typically <0.1 mg/L. Overall sensory evaluation by three independent persons not associated with this study revealed that the sample had a very strong, putrid smell, which was described as repulsive and intolerable.

Based on an evaluation of these characteristics, it was concluded that manure fermentation is associated with a highly reducing biochemical process. Moreover, it is apparent that dissolved oxygen (DO) in stored manure is almost completely depleted. These parameters are consistent with the sensory observation of very strong malodor, as many compounds that contribute to foul odor represent highly reduced metabolites such as ammonia and hydrogen sulfide.

The inventors conducted further experiments as outlined below to demonstrate that the offensive smell of manure can be lessened by increasing the level of dissolved oxygen present in a manure slurry solution, and by changing the biochemical environment of the manure slurry from very reducing (its native state) to more oxidative.

### Example 2.2

### Effects of Aeration on Manure Slurry

A series of trials where aeration of the manure sample was used as means of sample oxygenation revealed that introduction of atmospheric oxygenation was not a particularly effective approach for odor reduction. Furthermore, it became apparent that the process of natural fermentation of cattle manure rapidly depletes oxygen levels in the manure, even with constant aeration. Of note, it was observed that dissolved oxygen even in well-aerated manure drops rapidly to near zero during storage. Without being bound by theory, this rapid drop in dissolved oxygen levels can be explained by the fact the oxygen consumption rate of fermentation is considerably higher than the rate of oxygen transfer from the atmosphere to solution.

Further trials revealed that the accumulation of odors can be associated with storage conditions. This observation was inferred from comparison of odor emitted by freshly excreted fecal matter and manure that was obtained from the pit (i.e. manure that had been subject to storage for some period of time). As assessed by evaluation of the three-person sensory panel, manure samples from freshly collected specimens from the barn floor had considerably less odor in comparison to manure from the pit. However, the odor emitted from these samples after few days in storage was essentially the same as from pit manure.

Based on these results, it was concluded that the manure odor for the most part appears to be associated with interactions of two factors: (1) a predominantly reducing biochemical environment; and (2) the deficit of oxygen due to rapid depletion of all available oxygen.

### Example 2.3

### Preliminary Characterization of Treatment of Manure with Iron-Based Nano Particulate Catalyst

Given that aeration proved ineffective as a means of decreasing manure odor, the inventors used a catalytic reaction involving an iron-based nanoparticulate catalyst and hydrogen peroxide to change the ORP (oxidation-reduction potential) chemistry of manure fermentation from reducing to oxidizing, and at the same time endeavor to generate high levels of dissolved oxygen.

Initial experiments monitored base line effects of different permutations of catalytic reaction mixtures (i.e. various levels of iron-based nanoparticulate catalyst and hydrogen peroxide), and observed the effect of catalytic conditions on physico-chemical properties of manure.

Following preliminary trials, it was determined that, under the tested conditions, a suitable consistency of manure slurry was between about 5 and 15% dry matter (DM), a suitable range of hydrogen peroxide concentration in the reaction was in the range of 0.1% and 1%. Higher levels of hydrogen peroxide, e.g. up to about 15% can be used, but are impractical in practice. For further experiments, based on the preliminary trials, the concentration of hydrogen peroxide was set at 0.35%, and the level of catalyst required to sustain the reaction for at least 180 hours was set at 1% (vol/vol) of iron-based nanoparticulate catalyst stock solution. The concentration of iron-based nanoparticulate catalyst in the stock solution is in the range of about 1 to 5 mg/mL.

Dissolved oxygen was selected as a benchmark parameter for evaluating the robustness of the iron-based nanoparticulate catalytic system. The rate of the catalytic reaction was monitored in each sample, and the level of dissolved oxygen was compared between complete catalytic reaction (i.e. sample+citrate buffer+iron-based nanoparticulate catalyst+hydrogen peroxide); catalytic reaction medium (i.e. sample+citrate buffer+iron-based nanoparticulate catalyst, without hydrogen peroxide), and water containing hydrogen peroxide.

Baseline results for the production of dissolved oxygen by the iron-based nanoparticulate catalytic system were assessed using 100 mL of distilled water buffered with citrate to provide a pH of between approximately 3.5-3.8. To this medium, 1 mL of iron-based nanoparticulate catalyst stock suspension and 1 mL of hydrogen peroxide (35% stock) were added (complete catalytic reaction). The ORP potential of the resulting solution relative to RO water was between about 120 and about 160 mV. The catalytic reaction system demonstrated robust potential to generate high levels of dissolved oxygen over a period of many hours, as shown in FIG. 6. This is in contrast to buffered water containing either catalyst alone (catalyst in water), which showed a very low concentration of dissolved oxygen throughout the monitored period, and buffered water containing 0.35% hydrogen peroxide with no catalyst (water containing 0.35% hydrogen peroxide), which yielded an initial release of dissolved oxygen that rapidly dropped off, returning to basal levels after several hours.

Data showing dissolved oxygen (DO) levels in water provide a bench mark for basal levels when water DO is fully equilibrated with atmospheric oxygen. Under the atmospheric conditions tested, dissolved oxygen showed stable levels ranging from 3.9 to 4.2 mg/L. Amendment of water with hydrogen peroxide resulted in a modest increase in dissolved oxygen, but the values returned to basal levels after several hours. It is noteworthy that net generation of oxygen in the complete catalytic reaction system peaked approximately between 40 and 60 hours and then gradually began to decline, but sustained generation of high levels of dissolved oxygen was evident for at least 168 hours (7 days).

### Example 3.0

### Testing of Iron-Based Nanoparticulate Catalyzed Reaction for Manure Treatment

Evaluation of physicochemical parameters showed that the manure slurry used in this trial showed a pH of 6.4, the oxidation-reduction potential (ORP) (relative to reverse osmosis water) was typically between −550 and −600 mV, and dissolved oxygen typically was <0.1 mg/L. These parameters remained practically unchanged throughout the duration of the experiment (the control treatment).

Samples to be treated using a catalytic reaction using an iron-based nanoparticulate catalyst were buffered with citrate to maintain a pH between 3.9 and 4.3. Initial experiments showed that samples of slurry tended to have very strong buffering capacity. Thus, the process of slurry titration should be monitored and repeatedly adjusted in order to maintain desirable pH levels. Once the pH of the slurry was stabilized, the iron-based nanoparticulate catalyst and hydrogen peroxide (HP) were added to initiate the catalytic reaction. Control samples were equilibrated with reverse osmosis (RO) water.

To assess the effectiveness of iron-based nanoparticulate catalytic treatment, these preparations were set for incubation on the bench at room temperature. Measurements of pH, oxidation-reduction potential (ORP), and dissolved oxygen (DO) were taken at the following time intervals (hours): zero (T0), two (T2), twelve (T12), twenty-four (T24), and forty-eight (T48). The effects of catalytic reaction on manure treatment were compared to the effects of aeration which is a method commonly used in livestock industry to control odor and toxic emissions associated with manure storage.

The ORP potential (relative to RO water) of the samples subjected to catalytic treatment at T0 was approximately between 60-100 mV. Of note, DO levels initially did not differ among treated and untreated samples. However, the levels of DO in samples subjected to catalytic treatment started to increase gradually with time. At T2, DO levels in treated samples were approximately between 3-5 mg/L, and at T12 reached 6-10 mg/L. This level tended to be maintained at T24, but declined to approximately 2-4 mg/L at T48.

The samples were also subjected to odor evaluation. Based on the sensory evaluation, the presence of ammonia in treated samples was not perceptible. This result shows that by preventing emission of volatiles such as ammonia, catalytic manure treatment has the potential to not only to lower the level of odorous and greenhouse gas volatiles, but can also enhance the value of manure as a fertilizer by containment of nitrogen losses.

### Example 4.0

### Iron-Based Nanoparticulate Catalyzed Treatment for Manure Slurry Composting

Composting is one of most viable options to turn manure into valuable fertilizer; however, liquid manure slurry (for example as is frequently produced by dairy farm operations) is not readily amenable to the composting process. Therefore, in order to evaluate whether catalytic treatment with an iron-based nanoparticulate catalyst is compatible with the composting process, experiments were conducted where the basal manure slurry was amended with chopped wheat straw (having 8% moisture) to yield a slurry having a moisture content in the range of 75%. The amended slurry was then subjected to evaluation of the composting process in response to catalytic reaction treatment. The arrangement of samples for testing was prepared as follows: (1) complete iron-based nanoparticulate catalytic system (basal sample was first buffered with citrate to maintain pH between 3.9-4.3, and then 1 ml of iron-based nanoparticulate catalyst slurry and 1 ml of hydrogen peroxide (HP) were added to initiate the catalytic reaction), (2) partial catalytic system (basal sample was first buffered with citrate to maintain pH between 3.9-4.3, and then 1 ml of iron-based nanoparticulate catalyst was added), and (3) control (basal slurry sample volume was equilibrated to the same volume as for samples #1 and 2 with RO water).

These preparations were set for incubation on the bench at room temperature. The measurements of pH, ORP, and DO were taken at the following time intervals (hours): T0 (initial), T2 (2 hours), T24 (24 hours), and T48 (48 hours). Evaluation of physicochemical parameters of manure slurry amended with wheat straw revealed similar treatment effects as described above for unamended manure slurry sample treatment. Sensory evaluation also showed that catalytic treatment with an iron-based nanoparticulate catalyst and hydrogen peroxide was effective in ameliorating formation and emission of odorous compounds. Following this, samples were allowed to compost at room temperature without any additional chemical treatment for 4 weeks. During that time samples were agitated periodically.

Evaluation of physicochemical parameters of manure slurry amended with wheat straw after 4 weeks revealed the following representative results: untreated sample #3 in this trial showed a pH of 6.4, ORP (relative to reverse osmosis (RO) water) was approximately −550 and −570 mV, and dissolved oxygen was below detection limits (<0.01mg/L). So, these parameters remained practically unchanged throughout the observation period and are consistent with previous observations.

The ORP (relative to reverse osmosis (RO) water) of sample #1 which was subjected to iron-based nanoparticulate catalytic treatment at TO was approximately between 60 and 80 mV. However, the levels of dissolved oxygen (DO) in samples subjected to catalytic treatment started to increase gradually with time. At T2, DO levels were approximately between 3-5 mg/L, and at T12 reached 6-10 mg/L, and this level tended to be unchanged at T24, but declined to approximately 2-4 mg/L at T48. After 4 weeks of composting, the pH of this sample was approximately 4.5 to 5, the ROP potential was between −320 and −380 mV, and DO level was between 0.1 and 0.25 mg/L.

The ORP potential (relative to RO water) of the sample #2 which was similar to sample #1 in terms of buffering and catalyst content, but was not amended with hydrogen peroxide at TO was approximately between −60 and 0 mV. The levels of DO in sample #2 containing only the buffered catalyst were higher than sample #3, but only marginally. At T2, DO levels in sample #2 were approximately between 0.5 and 1 mg/L, and this level tended to be unchanged at T24, but declined to approximately 0.2 mg/L at T48. After 4 weeks of composting, the pH of this sample was approximately 5.6, the ORP potential was between −350 and −380 mV, and DO level was <0.1 mg/L.

The sensory quality of this sample set was evaluated by one assessor. Sample #1 was rated as best in terms of odor perception, sample #2 was somewhat worse than sample #1, but still tolerable. Sample #3 was found to be offensive and intolerable.

Based on the results of this experiment, the iron-based nanoparticulate catalytic system provided initial generation of oxygen at a level sufficient to change the oxidation-reduction potential (ORP) from highly negative (i.e. reducing) to moderately positive (i.e. oxidizing), albeit this effect was not sustainable. The chemistry of the composting environment reverted to reducing conditions after a short period of time.

Tests with the iron-based nanoparticulate catalyst alone or with addition of hydrogen peroxide showed that a low level of hydrogen peroxide is required to jump start the catalytic generation of oxygen and regeneration of hydrogen peroxide. In biological samples small amounts of hydrogen peroxide are generated as a product of normal metabolic processes, therefore it was of interest to test whether the content of naturally produced hydrogen peroxide could jump start the iron-based nanoparticulate catalyzed oxygen generation process. It is of interest to note that a very mild increase in oxygen content occurred in sample #2 which was buffered and contained iron-based nanoparticulate catalyst as sample #1, but which lacked an external source of hydrogen peroxide to jump start the catalytic reaction. Although a small gain in dissolved oxygen (DO) was apparent initially, this process was not sustainable and failed to produce practical levels of oxygen required to change the oxidation-reduction potential (ORP) from negative to positive.

Based on the foregoing results, in order to change the oxidation-reduction potential of the stored manure sample from negative to positive, the addition of an oxidant such as hydrogen peroxide is required. However, at the levels of buffering and hydrogen peroxide examined in this experiment, the catalytic reactions were not sustainable. Based on these results, the natural chemistry of cattle manure fermentation has strong reducing propensity and high oxygen demand.

Notwithstanding that the effect of the iron-based nanoparticulate catalyzed reactions decreased over time, under the tested conditions the catalytic treatment appears to enhance the composting process to some degree as evidenced by the disintegration of wheat straw (FIG. 7). Sample #1 (full catalytic reaction) shown on the left of the image is slightly more clear and lighter in colour and appears to contain smaller particles than sample #2 (middle) (iron-based nanoparticulate catalyst only with no hydrogen peroxide), which in turn is noticeably lighter in colour and slightly more clear than sample #3 (right side of image) (no treatment).

As evidenced by the difference in content of particulate matter in the samples shown in FIG. 7, the composting process in the untreated sample (#3) was least advanced, in comparison to treated samples (#1 and #2). Notably, the complete iron-based nanoparticulate catalytic reaction including hydrogen peroxide (sample #1) was most effective in enhancing the composting process, and showed higher level of particle size reduction as compared to samples #2 and #3. However, it is noteworthy that even buffering of the manure sample to create a mildly acidic environment together with the provision of an iron-based nanoparticulate catalyst was also quite effective in aiding the composting process (sample #2).

The foregoing results suggest that the catalytic treatment of manure can be beneficial for at least two desirable outcomes: 1) containment of nitrogen and sulfur within organic mass of the compost (i.e. by avoiding loss of nitrogen or sulfur in the form of gases such as ammonia or hydrogen sulfide), and 2) prevention of emission of highly odorous volatiles such as ammonia or hydrogen sulfide. For compost that will be used as fertilizer, conservation of nitrogen is of significant value due to the value of nitrogen as part of a fertilizing composition.

The foregoing results also provide proof of principle that application of an iron-based nanoparticulate catalytic process can be effective in enhancing the manure composting process. While the preliminary tests described above revealed that the chemistry of natural fermentation of cattle manure requires high oxygen levels, the first round of practical application of the iron-based nanoparticulate catalytic reaction in the treatment of manure slurry and manure slurry amended with straw generated some unanticipated outcomes. The fact that even such a robust and sustained oxygen generation as is provided by an iron-based nanoparticulate catalytic reaction (see FIG. 6) was not sufficient to provide manure samples with a positive oxidation-reduction potential over a sustained period of time was particularly surprising. Without being bound by theory, the drop in dissolved oxygen levels is believed to have occurred because the oxygen consumption rate during manure fermentation exceeded the rate of oxygen generation by the present catalytic reaction.

### Example 5.0

### Sustained Generation of Oxygen by Iron-Based Nanoparticulate Catalyzed Reaction

Since the deficit of oxygen was originally considered to be a drawback, the inventors further developed the iron-based nanoparticulate catalytic reaction so that it would be capable of generation of reasonable levels of dissolved oxygen over a sustained period.

Further experiments demonstrated that sustained production of dissolved oxygen could be achieved by simply recharging the reaction, and such strategy was shown to allow the process to continue. However, repeatedly recharging the reaction may be undesirable from the standpoint of developing an economical treatment process. Further experiments in larger vessels, and in particular in a 10 L reaction vessel, showed that the drop in dissolved oxygen levels occurred at much higher rate than initially anticipated, and the oxygen consumption rate during manure fermentation exceeded the rate of oxygen generation by the catalytic reaction.

In order to sustain the iron-based nanoparticulate catalytic process, it was necessary to re-charge the reaction at first every 1 to 2 hours, and later every 4 to 8 hours. Although the reaction eventually became more stable, and the re-charging needs become less frequent, the deficit of oxygen was still considered to be a drawback from the perspective of developing a large-scale process for commercial application.

The inventors therefore re-focused further development of the process. Further experiments revealed that the high rate of oxygen consumption was correlated with the biological activity of the slurry. The inventors therefore assessed a variety of systems where the catalytic reaction would operate in the environment that is more dependent on chemical rather than biological activity. This was done by conditioning the manure at acidic or basic pH prior to initiating the iron-based nanoparticulate catalyzed reaction.

### Example 6.0

### Testing of Different Conditions for Conditioning a Waste Stream

Diluted manure slurry aliquots (100 mL) were obtained as in Example 1.0, with the manure being collected directly from the storage pit. Samples were conditioned with various strong acids to maintain pH between 1.5 and 2, and various strong bases to maintain pH between 12 and 13 (nitric, hydrochloric and sulfuric acids, and sodium or potassium hydroxide). The initial experiments revealed that samples of slurry tended to have very strong buffering capacity, and the process of slurry conditioning was monitored and repeatedly adjusted in order to maintain desirable pH levels. Thus, the best approach to achieving the desired pH was determined to be a titration approach, rather than the addition of a specific amount of acid or base. Once the pH of the samples was stabilized, then the iron-based nano-catalyst (1 mL of stock slurry) and hydrogen peroxide (HP) (1 mL of 35% stock solution) were added to initiate the catalytic reaction (complete catalytic reaction, CR). Control samples were equilibrated with RO water.

Following a series of preliminary experiments, under the tested conditions it was established that better immediate results could be obtained with alkaline conditioning using either sodium hydroxide or potassium hydroxide. In assessing the conditioned samples, it was found that acidic conditioning was initially less effective in immediate reduction of odor, but over time as the catalytic reaction advanced, the difference became negligible. Without being bound by theory, it appears that conditioning with acid resulted in an initial burst release of gases. Further experiments revealed that if the titration of acid or base is conducted sufficiently slowly, conditioning under acidic or basic conditions was effective to reduce odor.

Following acid or alkaline conditioning, the manure slurry can be stored for long time. The pH of the conditioned manure slurry tends to drift slightly over time, but can be returned to the desired pH by addition of further acid or base.

The second step in the treatment process is treatment in a reaction catalyzed by an iron-based nanoparticulate catalyst with hydrogen peroxide. This process results in the decomposition of organic matter, with co-generation of oxygen and reactive oxygen species, for example according to Equations 1-7.

As a bench mark parameter for robustness of the iron-based nanoparticulate catalytic system, the measure of dissolved oxygen was adopted. Basal rates of dissolved oxygen produced by the catalytic reaction were monitored in samples, and the levels of dissolved oxygen were compared between the complete catalytic reaction in samples conditioned under acidic and alkaline conditions, and control samples.

The initial set of experiments conducted in small volume (100 mL) glass vessels was followed by experiments in larger reaction vessels. The tests using experimental treatment arrangements as described above were conducted in glass beakers (reaction volumes 1 and 2 L), stainless steel container (reaction volume 2 L), and plastic containers (reaction volumes ranging 20 L to 200 L). A reaction in 200 L was set for long term monitoring. Volumes of all reactants were scaled accordingly.

The manure samples processed in these experiments were also subjected to sensory evaluation by 7 independent observers (representative of the local community) to evaluate smell of samples presented in random order. None of the evaluators was aware of sample identity.

Initially, the key laboratory measurements were focused on the evaluation of the base line effects of various permutations of catalytic reaction mixtures (i.e. various levels of nano-catalyst and hydrogen peroxide (HP)) and observations of catalytic conditions on physico-chemical properties of manure. Following preliminary trials, it was determined that a suitable consistency of manure slurry was between 5 and 15% (dry matter, DM), the hydrogen peroxide concentration in the reaction was set at 0.35%, and the level of catalyst required to sustain reaction for at least 24 hours was set at 1% (v/v) of iron-based nanoparticulate catalyst stock solution.

The evaluated variables were examined in various permutations with each variable for slurry as a primary treatment factor (either raw, freshly agitated slurry, or slurry subjected to acid or alkaline conditioning), in combination with hydrogen peroxide (HP), or in combination with the complete catalytic reaction (CR) which includes the iron-based nanoparticulate catalyst and hydrogen peroxide.

These experiments demonstrated that oxygen consumption in raw manure was rapid. Oxygen content in these samples declined to a very low level (<0.1 mg/L) after just 30 minutes, and was below the detection limit (i.e. <0.01 mg/L) after 2 hours. In contrast to raw slurry, slurries conditioned either under acidic or alkaline environments showed slightly higher levels of dissolved oxygen for 4 hours, and levels around 0.1 mg/L were still detectable after 12 hours. Amendment of slurry with the complete iron-based nanoparticulate catalytic reaction increased initial levels of dissolved oxygen, and the relatively high levels were maintained for 24 hours.

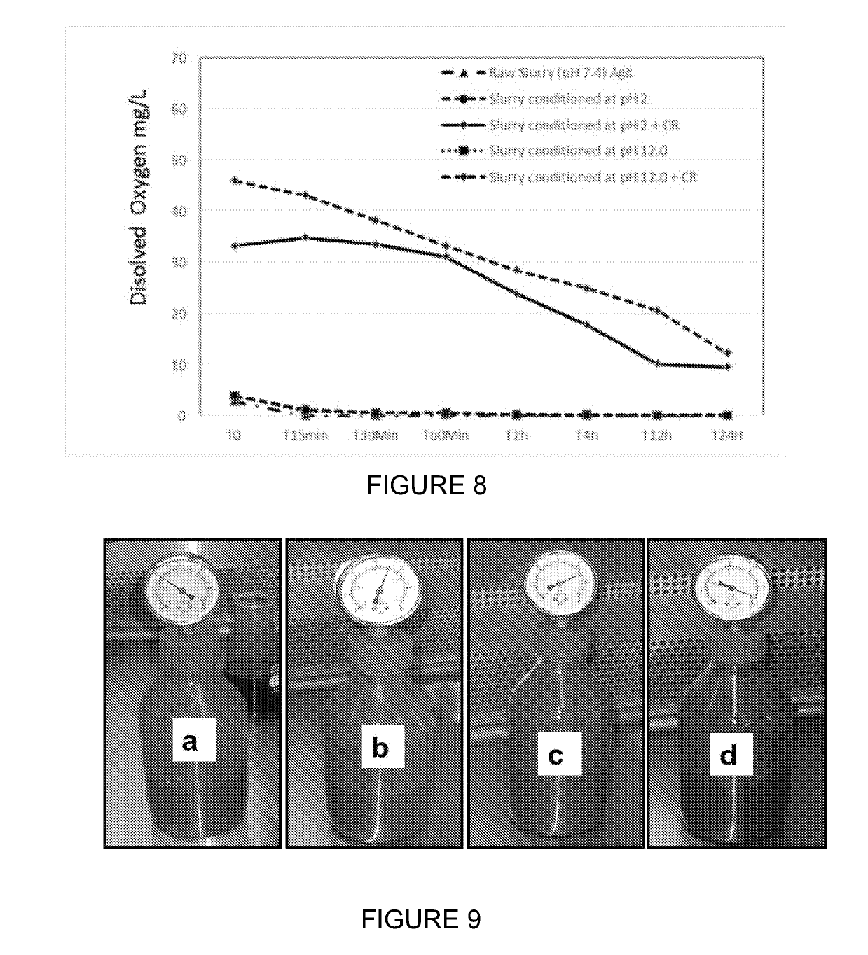

A summary of the findings from these experiments is presented in FIG. 8. The highest levels of dissolved oxygen were observed in slurry conditioned at pH 12.0 and subjected to treatment with complete catalytic reaction (CR). The next highest levels of dissolved oxygen were observed in slurry conditioned at pH 2.0 and subjected to treatment with complete catalytic reaction (CR). Slurry conditioned at pH 2.0 and slurry conditioned at pH 12.0 (without treatment with catalytic reaction) had only slightly higher levels of dissolved oxygen than raw slurry at pH 7.4 that had been agitated.

Based on sensory observations, reduction of odor was apparent in all conditioned samples, but more so in samples that, in addition to acid or alkaline conditioning, were also subjected to the complete catalytic reaction.

It was determined that the desirable effects of halting microbial fermentation can be obtained by conditioning manure in either an acidic environment (e.g. an effective pH less than 1.5) or alkaline environment (e.g. a pH in the range of about 12 to 13). Under the conditions tested, it was noted that conditioning under acidic conditions was less effective in immediate reduction of odor than conditioning under alkaline conditions.

Following a preliminary experiment, under the tested conditions it was established that the desirable immediate results obtained by halting microbial fermentation could be achieved using either sodium hydroxide, potassium hydroxide, or ammonium hydroxide. Subsequent experiments revealed that conditioning with acid, e.g. hydrochloric acid or sulfuric acid, also works to reduce odor, but initially produces a release of gas from the waste stream, which can be avoided or lessened by adding the acid slowly in a titration process.

Given that the nature of bacteria found in the waste of many different animals, including humans, is similar (see e.g. Veterinary Microbiology, edited by Dwight C. Hirsh, N. James MacLachlan, Richard L. Walker, Ames, Iowa: Blackwell Pub., 2004 and Microbiology: A Human Perspective, Eugene W. Nester et al., New York: McGraw-Hill, 2012, both of which are incorporated by reference herein) it can be soundly predicted that waste streams from other animals besides cattle, including pigs, sheep, goats, horses, chickens, turkeys and other poultry, zoo animals, humans and the like, can be conditioned under an acidic pH of less than 1.5 or an alkaline pH in the range of about 12 to 13.

Without being bound by theory, based on the evaluation of basic physico-chemical properties of raw manure slurry and slurry conditioned under acidic or alkaline conditions, the inventors infer that the raw manure fermentation is associated with a highly reducing biochemical process, which can explain high oxygen demand. The reducing reactions are considerably retarded when the slurry is subjected to acidic or basic conditioning, but still, consumption of oxygen remains very high. This is most likely due to residual biochemical activity. However, introduction of the treatment process using an iron-based nanoparticulate catalyst had a strong effect on oxygen generation in a sustainable fashion. It is apparent that, although both acid and alkaline conditioned slurry still showed high oxygen utilization, this oxygen demand can be met by the catalytic reaction. These parameters were also consistent with the sensory observations of the samples, where reduction of odor was apparent in all conditioned samples, but more so in samples that, in addition to acid or alkaline conditioning, were also subjected to the catalytic reaction.

### Example 7.0

### Evaluation of Odor Control

For bench testing of effects of the iron-based nanoparticulate catalytic reaction medium using acid or alkaline conditioned manure, slurry was comprised of manure slurry samples as described above. Respective samples of raw slurry, or slurry subjected to treatments, were evaluated by a panel of volunteers. The evaluation was done in randomized trials, where the evaluating persons were not aware of sample identity. The evaluators were asked to provide their overall impression, as well grade the sample with respect to odor quality and intensity.

The samples were first evaluated approximately 1 hour after treatment, and then over the next few days. Upon initial evaluation, the impression of all people involved in the process was similar with regard to raw (untreated) samples. The descriptive terms most often used were: repulsive, sickening, and intolerable. The impression of evaluators of treated manure samples was drastically different. All reviewers found treated samples as tolerable, and not offensive. Some detected some smell of ammonia. Generally samples conditioned under alkaline conditions were evaluated more favorably by reviewers in this experiment in comparison to samples conditioned under acidic environment.

Interestingly, all reviewers were under the impression that the odor quality worsened over time in the untreated samples, but improved in all treated samples. After a few days, most evaluators stated that the treated samples did not have a smell of manure at all, whereas some commented that there was a faint smell, but tolerable. After approximately 3 weeks, every reviewer found the untreated sample to be intolerable, whereas there was a general consensus that no odor was emitted from the treated samples. The evaluation process was reproduced several times, as other aspects of the research were progressing. Notably, evaluation of larger reaction vessels showed the same results.

The inventors have evaluated long term storage effects of iron-based nanoparticulate catalyzed manure treatment technology in a 200 L reactor maintained at ambient temperature. On initial evaluation there was no perceptible odor in the head space of the reactor, even after vigorous agitation. No odor was noticed after a 14-month treatment period, although some observable reduction in particle size was noted.

### Example 8.0

### Evaluation of the Effects of Manure Treatment on Gas Generation

The foregoing experiments demonstrate that the emission of odorous substances in manure subjected to treatment with an iron-based nanoparticulate catalytic reaction is essentially halted, or at least reduced to non-perceptible levels. This indicates that the biological fermentation is either totally abolished or redirected towards different activities. A series of experiments focused on broad evaluation of gas generation activity by treated manure slurry was conducted to evaluate the possible generation of other gaseous products, by either biological or chemical processes.

To conduct such experiments, the inventors designed special reaction bottles fitted with air tight rubber stoppers. The stoppers were fitted with air tight Tygon™ tubing (approximately 1 mm internal diameter). This assembly allowed the gases generated during manure slurry storage to be vented to another vessel filled with water, and for the gas bubbles produced in the reaction bottle to be visually observed.

A stock manure slurry was prepared as described above, and 400 mL aliquots of raw slurry samples and treated slurry samples were placed in respective control and treatment bottles. The reactions in the bottles were monitored for 4 weeks.

There was notable gas generation activity in the bottle containing raw (untreated) slurry, which was evidenced by visible gas bubbles being vented to the water filled container. In contrast, there was no gas generation activity in the bottle containing the treated slurry. The inventors estimate that the volume of gas generated in the reaction bottle was significant, but were unable to measure exactly the volume of gas generated by the slurry in the absence of appropriate instruments. Further observations from several trials led the inventors to conclude that the gas released to the atmosphere represents only a fraction of total gas generated during manure fermentation. The inventors found that large quantities of gas generated during biological fermentation of manure is actually trapped within the matrix of the slurry, and therefore any attempt at measurement of gas synthesis based on gas flow would grossly underestimate the total volumes of gas generated.

In order to better illustrate the magnitude of gas generation, the inventors developed a reaction bottle where rather than measuring gas flow, gas pressure generated in the bottle in association with manure fermentation was measured. In order to construct this reaction vessel, an air tight screw cap was fitted with a pressure gage, and once charged with the slurry, this device allowed the inventors to monitor the pressure generated by the produced gases in the reaction bottle. The total volume of bottle was 1150 ml. If 500 ml of treated or untreated slurry is placed in the reaction bottle, there is 650 ml of bottle space available for gas collection. Since the inventors were monitoring pressure generated by gas, they were able to account for changes in volume of all gases generated in the vessel, that is, the gas released to the atmosphere (trapped in the head space in the bottle) and gas dissolved in the slurry.

The pressure in the reaction bottle containing raw (untreated) manure slurry started to rise shortly after the bottle was closed, and continued to increase gradually to relatively very high levels. In contrast, in the reaction bottle containing treated manure slurry, the needle of the gauge did not move from its initial position “0” over time.

The experiments showing significant generation of large quantities of gas are remarkably reproducible. Of note, in one of the experiments, the pressure in the bottle containing untreated slurry reached a pressure as high as 25 psi. This experiment was terminated because the inventors feared that the reaction bottle may undergo de-compressive explosion. Similar results were observed in several consecutive experiments conducted. The pressure changes in the reaction bottle containing raw (untreated) manure slurry documented during one representative experiment is shown in FIG. 9.

Notable changes in pressure were observed just 4 days after the slurry was placed in the bottle. Approximately 10 days later, the pressure in this reaction vessel reached 10 psi level (panel a). The pressure documented 9 days later was approaching 18 psi (panel b), and 3 days later, the pressure increased to 22 psi (panel c). 3 days later the pressure exceeded 28.5 psi (which was almost at the limit of the pressure gage scale), and decision was made to terminate this experiment.

The value of gas pressure in the bottle can be used to calculate the volume of gas generated in the bottle according to the equation

P1*V1=P2*V2 27)

where P1 (absolute)=14.7 psi, P2 (absolute)=28.5 psi (gauge reading)+P1 14.7 psi (absolute), V2=650 ml (air space in the bottle above slurry, which is equivalent to volume of the gas at P2), V1=volume of the total gas generated in the bottle at atmospheric pressure.

Therefore substituting equation V1=P2*V2/P1 with the values recorded (43.2*650/14.7), at the termination of the reaction, the manure fermentation process of untreated manure slurry generated 1910.2 ml of gas. Since the consistency of slurry in the reaction bottle was 5% DM (dry matter), 500 ml slurry contained 25 g manure. Therefore based on this experiment, it can be estimated that under these experimental conditions 1 gram of manure DM generated 76.41 ml of gases.

Because the experiment was terminated for practical reasons, it is unknown what would be the ultimate level of generated pressure. Nevertheless, the above discussed experiments demonstrated the very high potential for gas generation when the manure slurry is stored. It is noteworthy that the initial rate of gas generation was somewhat sluggish, as it took some time for the fermentation process to gain momentum, but as fermentation was advancing (approximately after 10 days), the gas generation kinetics changed, and the volumes of gas generated were increasing exponentially.

### Example 9.0

### Evaluation of Manure Treatment on Pathogenic Bacteria Load

Microbiological evaluation was performed following standard procedures for qualitative and quantitative evaluation of coliform micro-organisms. This test is a standard for evaluation of sanitary qualities of drinking water. Samples of manure slurry were prepared as described above. Samples of raw (untreated) slurry and treated slurry were subjected to bacteriological evaluation. Appropriately diluted samples were plated on MacConkey agar (BBL, Beckton Dickinson), and incubated at 37 degrees C. for 24 hours. Following incubation colony forming units were counted, and number of bacteria present in the samples was calculated. For further identification of slow growing bacteria, the plates were re-incubated for another 24 hours.

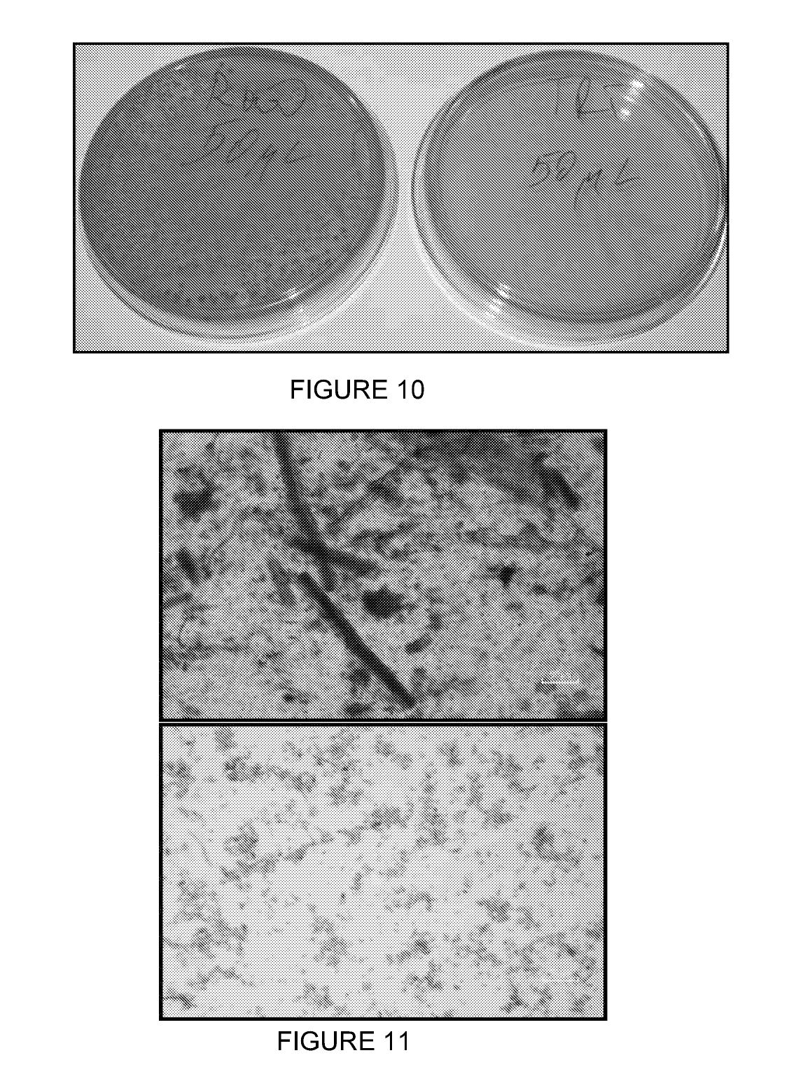

As expected, plates with culture from untreated slurry showed extensive growth of coliform bacteria. In contrast, there was no growth of any microorganisms on plates where slurry that had been treated with a complete catalytic reaction including iron-based nanoparticulate catalyst and hydrogen peroxide was cultured. Examples of microbiological culture obtained from untreated and treated manure slurry are shown in FIG. 10.

FIG. 10 shows representative photographs of culture plates inoculated with 50 microliters of untreated manure slurry (left plate) and 50 microliters of treated manure slurry (right plate). Notably, the plate inoculated with untreated slurry showed copious growth of coliform bacteria, but there was no growth on the plate inoculated with treated slurry. The plates were re-incubated for the next 24 hours, and growth of swarming colonies consistent with the morphology of Proteus spps. were seen only on the plate inoculated with untreated manure slurry, whereas there was no growth on the plate inoculated with treated slurry.

Based on estimated counts, raw manure slurry contained approximately 1.5×10¹² coliform microorganisms. Since under the described conditions there was no apparent growth on the plate inoculated with treated slurry, this experiment demonstrates that the sample manure subjected to treatment was essentially sterilized. Based on these results, it can be soundly predicted that treatment of a waste stream containing coliform bacteria or other potentially pathogenic bacteria using an iron-based nanoparticulate catalyzed reaction with hydrogen peroxide can be used to kill or inactivate pathogenic bacteria in the waste stream.

### Example 10.0

### Application of Iron-Based Nanoparticulate Catalyzed Reaction for Manure Detoxification

Waste streams such as manure may contain a wide range of biologically active organic compounds (e.g. hormones, drugs, pesticides, environmental contaminants, and the like). The inventors demonstrated that an iron-based nanoparticulate catalyzed reaction could be used to degrade toxic agents that may be present in waste streams such as manure using phenol as a model chemical. Phenol was selected for this study because the phenolic ring is a basic building block of many compounds such as veterinary drugs, nonylphenols, phthalates, bisphenol A, polycyclic aromatic hydrocarbons, and the like.

A 1 mg/ml stock solution of phenol was prepared. The initial sample was analyzed using UV/Vis spectrophotometry, and it was established that phenol at a concentration of 1 mg/ml showed absorbance value equivalent to 2.7 AU @ 285 nm. The aliquots of this solution were then subjected to catalytic reaction in a medium comprising citrate buffer, an iron-based nanoparticulate catalyst, and 0.35% hydrogen peroxide as described above, and changes in absorbance were monitored periodically. According to the Beer-Lambert law, concentration of a compound in a sample is directly proportional to absorbance. Thus, any decline in absorbance in the sample subjected to the iron-based nanoparticulate catalytic reaction would indicate that the test compound is undergoing catalytic degradation.

It was noted that absorbance of phenol in the reaction vessel declined in a linear fashion, and after approximately 16 hours of catalysis there was no measurable phenol in the reaction sample. These results demonstrate that an iron-based nanoparticulate catalyzed reaction utilizing hydrogen peroxide in aqueous solution can be used to break down organic compounds, including biologically active organic compounds present in a waste stream such as manure.

Given the demonstrated utility of the iron-based nanoparticulate catalyzed degradation process to break down phenol, a common industrial pollutant, it can be soundly predicted that some embodiments of the present invention have potential utility in breaking down pollutants and environmental toxins that contain aromatic hydrocarbons in the treatment of waste streams other than agricultural waste streams, for example industrial effluents or municipal sewage. It can also be soundly predicted that some embodiments of the present invention have potential utility in breaking down pollutants such as antibiotics, hormones and or drugs that might be present in a waste stream produced from an animal source, for example manure or municipal sewage.

### Example 11.0

### Evaluation of Particle Size in Treated Manure

Based on previous results obtained by the inventors, it is known that an iron-based nanoparticulate catalyzed reaction can depolymerize complex molecules of structural carbohydrate such as cellulose or hemicellulose, and complex phenolic compounds such as lignin. The inventors conducted a study confirming that the iron-based nanoparticulate catalyzed reaction degrades complex structures of manure mass very efficiently under both acidic and alkaline conditions.

The results of an example of a representative experiment showing the degradation of manure mass by iron-based nanoparticulate catalyzed reaction are shown in FIG. 11. FIG. 11 shows microscopic images of raw (untreated) slurry and slurry subjected to catalytic reaction under alkaline conditions. Both samples were incubated for 14 days at room temperature. It is noteworthy that the decomposition of large particles in untreated sample (top panel) was relatively very inefficient in comparison to treated sample (bottom panel).

Particle size reduction is a desirable attribute for the use of processed manure as quality fertilizer. For example, smaller particle size may assist in the uptake of nutrients from a fertilizer end product obtained from treatment of a waste stream such as manure.

### Example 12.0

### Use of Treated Manure as Safe Value Added Fertilizer

As demonstrated above, treatment of manure with a catalytic reaction using an iron-based nanoparticulate catalyst results in a treated product that is virtually sterile and odor free. Thus, the product can be used directly as a fertilizer, for example in agricultural or landscaping applications.

Also as demonstrated above, the result of the catalytic degradation caused by the iron-based nanoparticulate catalyzed reaction is the decomposition of both organic and inorganic matter present in the manure. Complex polymeric materials constituting the manure biomass are hydrolyzed to smaller molecules. This type of processing is suitable, for example, to produce a fertilizer from the manure that can safely be applied in agricultural or landscaping applications. The breakdown of complex molecules to smaller molecules can assist in further assimilation of the resulting product when it is applied as a fertilizer in soil. Because larger particles are decomposed at this stage, the final product can be applied in liquid form (e.g. field irrigation), or the liquid product can be dewatered and applied in the field in granular form.

In embodiments in which potassium hydroxide is used for the conditioning step, the value of the downstream fertilizer product is increased by the addition of the valuable nutrient potassium. In some embodiments, further treatment using customized titration of the processed manure slurry with acids such as hydrochloric, nitric, sulfuric, or phosphoric acids will be implemented as required to generate various valuable potash salts, also termed as potassic fertilizers, such as potassium chloride (KCl), potassium sulfate (K₂SO₄), potassium nitrate (KNO₃), or potassium phosphates (KₓPO₄). Various potash salts are routinely used as fertilizers throughout the world. Thus, a high quality, customized fertilizer that may meet local soil application requirements for virtually any NPK content and any pH range may be produced.

### Example 13.0

### Procurement of High Value Bioproducts

As noted above, lignin is a valuable component of cattle manure. Following several preliminary experiments, the inventors determined that lignin in the manure can be extracted efficiently using a relatively simple hot alkaline extraction process, followed by a dewatering step or acid precipitation. Under the tested conditions, the best results are obtained when the extraction is performed at high temperature, for example 90 to 98° C., with addition of several serial steps of extraction, separation, purification, and harvesting of additional specific compounds during the process.

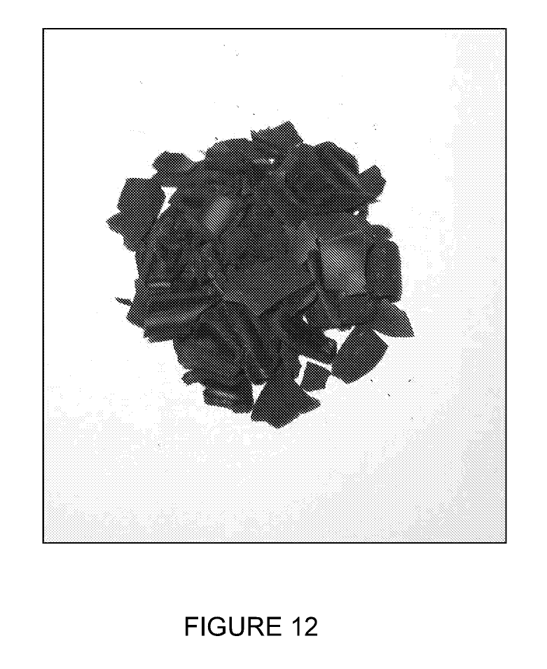

To conduct this experiment, a fresh sample of manure was collected from the University of Saskatchewan dairy barn. The sample was air dried, and approximately 30 g of dry manure was dispersed in water to a total volume of 1 L to form a slurry. The slurry was titrated with NaOH to pH 12, and conditioned for 1 hour at room temperature (RT). Following conditioning, the pH of the slurry was re-adjusted to a final value of 12.5. The sample was then subjected to a hot alkaline extraction at 95 to 98° C. for 24 hours. The processed slurry was filtered through a paper filter (approximately 10 μm pore size). The filtrate was collected and dewatered by evaporation, which resulted in the dry lignin precipitated in the form of black colored briquettes (photograph of the resulting product shown in FIG. 12). In this example, approximately 19 g of lignin briquettes were obtained from 30 g of manure (dry matter, DM).

The obtained lignin material was subjected to further analysis. Spectral analysis of the product using UV-Vis spectrophotometry showed the absorption pattern with absorbance maxima peak at approximately 280 nm, which was essentially the same as the absorption spectra of high purity lignin from Sigma (USA) used here as a reference.

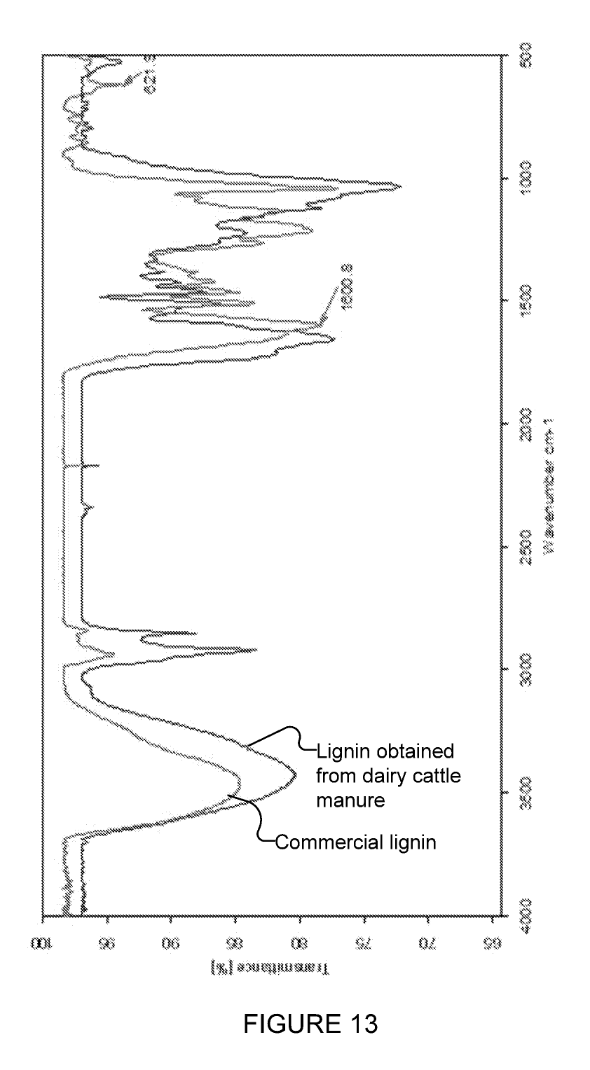

The extracted lignin was further analyzed using Fourier transform infrared spectroscopy (FTIR). FTIR imaging was performed using a Hyperion 3000 IR microscope coupled to a Tensor 27 interferometer (Bruker Optics, Billerica, Mass.). A KBr-supported Ge multilayer beamsplitter and a 64×64 pixel Focal Plane MCT detector (Santa Barbara Corp., Santa Barbara, Calif., USA) were used to measure spectra in the mid-infrared spectral region. Interferograms were recorded by scanning the moving mirror at 2.2 kHz, to an upper frequency limit of 3950 cm⁻¹ and with a spectral resolution of 4 cm⁻¹. 4×4 pixel binning was performed during acquisition. Single channel traces were obtained using the fast Fourier transform algorithm. Data analysis was performed using OPUS version 6.5 (Bruker Optics, Billerica, Mass., USA). FTIR spectra obtained from lignin isolated from manure and of reference lignin are presented in FIG. 13. High purity lignin, used here as a reference, was purchased from Sigma (USA) (red line, labelled commercial lignin). Spectra of lignin isolated from dairy cattle manure in this experiment is shown in blue (line labelled lignin obtained from dairy cattle manure).

The foregoing FTIR analysis confirmed that spectra of lignin isolated from manure are comparable or identical with spectra of highly purified lignin (FIG. 13). Notably, the pattern of lignin tracing obtained from manure (blue, dairy cattle manure) is essentially the same as reference lignin tracing (red, commercial lignin), with the exception of small shift around the 1600 wavenumber region towards higher wavenumber, and the absence of deflection at 610 wavenumber region.

Differences in FTIR spectra of lignin from different sources are well characterized and discussed in the literature. Without being bound by theory, such spectral differences simply reflect structural variability of lignin from different plant material. Lignin is a complex polymer of aromatic alcohols (p-coumaryl, coniferyl, and sinapyl) which constitute the primary structure, cross-linked to form a racemic macromolecule. Although the primary structure of lignin is similar regardless of origin, there are major variations in molecular masses depending on source biomass. The differences in FTIR spectra are mostly associated with variations in secondary structure of lignin, i.e. the relative content, crosslinking pattern, and special distribution of primary constituents of lignin molecules.

Principally, lignin is obtained as a by-product of wood pulping via the Kraft process (sulfate pulping) and as a result most commercially available lignin is more or less sulfated. In recent years there has been considerable interest in industrial applications of lignin. High sulfur content in lignin affects its quality for some industrial applications, and the experimental work done with low sulfur lignin and with lignin obtained using the Organosolv process has shown very promising results.

It is believed that lignin extracted from manure as in this example is most likely in its native (chemically unmodified) structure, and therefore has potential application in areas where low sulfur or native lignin is necessary or desirable. Furthermore, the lignin isolated from manure in this example does not appear to contain sulfur, as evidenced by absence of a deflection at the 621 wavenumber.

Based on the results of this experiment and the inventors' observations, manure appears to be a very rich biomass source for obtaining lignin. The high level of lignin present in manure indicates that very little (if any) natural lignin present in forage is utilized by the animal, and the bulk of manure lignin is the product of gut microbial digestion of plant material consumed by an animal. This example demonstrates that a 2 L reactor can be used to obtain native lignin from dairy cattle manure. Based on these results, it can be soundly predicted that the process can be scaled up to process larger volumes of manure, and that manure obtained from other animals or other waste streams that contain lignin can also be used to obtain lignin from a waste stream.

Crystalline cellulose was also obtained from manure with a 10-20% yield based on the amount of dry matter in the manure, and represents a high value bioproduct category. The catalytic process also generates degradation products such as organic acids which can serve as green platform chemical inputs for the chemical industry.

Based on these results and the similarity in composition of waste streams produced by different animals such as cattle, sheep, goats, pigs, horses, chickens, turkeys and other poultry, and zoo animals, it can be soundly predicted that valuable compounds such as lignin, crystalline cellulose and a wide range of platform chemicals can be obtained from other waste streams such as manure from other animals, municipal sewage, and other industrial waste streams.

### Example 14.0

### Scale-Up of Manure Processing Technology

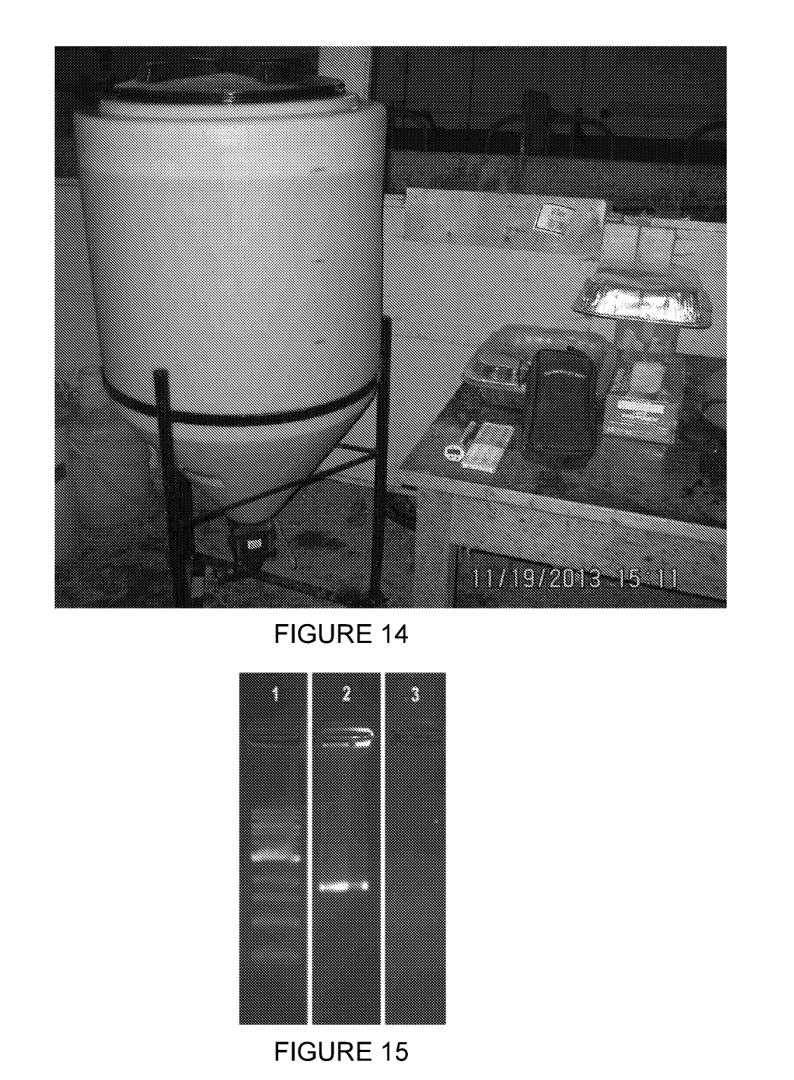

All of the basic outcomes of the processing technology observed at the lab bench level as described above were confirmed using reactors with 10 and 20 L capacity. The experiments using larger reactors showed that the developed concept of manure processing technology is readily scalable. A reaction vessel with 200 L capacity was also tested (FIG. 14).

FIG. 14 shows a prototype of a small scale up manure treatment reactor. The reactor is made from a plastic 60 gallon commercial grade container with a cone shaped hopper. At the outlet of the hopper has been fitted a 2″ valve for evacuation of the final product. The working capacity of the reactor is 200+ L.

### Example 15.0

### Breakdown of Genetic Material in Waste Streams

Because the microbiomes of farm animals are potential reservoirs of antibiotic resistance genes, which could potentially result in the transmission of genetic material to other animals or to humans if manure is used as a fertilizer, the inventors conducted experiments to assess whether the catalytic reaction step can break down or inactivate organic materials, including genetic material. The experiments conducted demonstrate that the catalytic reaction step can degrade pyridine, pyrimidine and imidazole rings, and as well as purine and pyrimidine bases, and nucleotides.

### Example 15.1

### Breakdown of Nucleic Acid Building Blocks by Catalytic Treatment

In this example, adenosine monophosphate and adenosine triphosphate were used as model molecules to assess the effect of the catalytic reaction step on purines, and their nucleosides and nucleotides. For the assay, stock 1 mg/ml solutions of adenosine monophosphate and adenosine triphosphate were prepared in citrate buffer (pH 3.8). The catalytic reaction medium comprised iron-based nanoparticles (1% v/v of stock solution) and 0.35% hydrogen peroxide in citrate buffer (pH 3.8). The control medium was citrate buffer (pH 3.8) and iron-based nanoparticles (1% v/v of stock solution). The assays were activated by mixing the respective stock solutions with catalytic reaction medium or control medium to a final concentration of substrates of 0.15 mg/ml, and the assays were incubated in a water bath at 90° C. for 3 hours. Following this, all samples were scanned using UV-Vis spectrophotometry at a spectral range from 200 nm to 750 nm. The absorbance maxima for adenosine monophosphate and adenosine triphosphate were established in the control media to be between 260 to 270 nm. There was no measurable absorbance in this range in assays that were subjected to treatment in the catalytic reaction medium. Therefore it was concluded that under the assay conditions, adenosine monophosphate and adenosine triphosphate were completely degraded by the catalytic reaction.

Because purines and pyrimidines are building blocks of nucleotides, it can be predicted from the foregoing experiment that nucleic acids are also susceptible to degradation by the catalytic reaction step. Further experiments confirmed this prediction.

### Example 15.2

### Breakdown of Nucleic Acids by Catalytic Treatment

To confirm that the catalytic treatment step is capable of breaking down genetic material to reduce the risk of antibiotic resistance transfer via putative plasmids harbored in manure pathogens, the plasmid pUC19, commonly used as a cloning vector in E. coli, was selected for study. The molecule is comprised of a double-stranded circle of DNA, 2686 base pairs in length, and carries a 54 base-pair multiple cloning site polylinker that contains unique sites for 13 different hexanucleotide-specific restriction endonucleases (Narrader et al., 1983). It contains an ampicillin resistance gene (amp^{R}), and an N-terminal fragment of β-galactosidase (lac Z) gene of E. coli. The bacteria which have taken up the plasmid can be differentiated from cells which have not taken up the plasmid by growing it on media with Ampicillin.

25 μL aliquots of the plasmid stock solution (100 ng/μL) were added to catalytic reaction medium (iron-based nanoparticles (1% v/v of stock solution) and 0.35% hydrogen peroxide in citrate buffer, pH 3.8), and the assays were incubated in water bath at 70° C. for 4 hours. Following this, the plasmid DNA from assays was extracted using ethanol and subjected to routine gel electrophoresis. There were no detectable DNA bands in lanes from samples treated with catalytic reaction medium (lane 3 of FIG. 15), whereas a band of control DNA was clearly visible (lane 2 of FIG. 15), and it was concluded that the pUC19 plasmid was degraded by these reaction conditions. A photograph of the resultant gel is shown in FIG. 15.

Thus, treatment of agricultural waste streams with a catalytic treatment step as described herein provides a tool for the neutralization of genetic material such as DNA and RNA, including for example antibiotic resistance plasmids that may be present in such waste streams, including in manure.

### Example 16.0

### Enhanced Procedure for the Production of High Value Bioproducts from Lignocellulosic Biomasses

Experiments were conducted where manure was subjected to long term degradation process at various pH conditions, and it was observed that alkaline pre-treatment of manure facilitated further processing. Furthermore, it was observed that when alkaline conditioned manure was further treated with hydrogen peroxide, the resulting reaction generated vigorous effervescence, and rudimentary measurements revealed that considerable amounts of oxygen are elaborated during this process. It was also observed that when the mixture was heated for several minutes, there were visible changes in color and texture of solid particles in manure.

Based on these observations, it was postulated that some catalytic process must be behind such vigorous generation of oxygen even at alkaline pH. Because of the clearly observable changes in the morphology of the solid components of manure, the process may be generating reactive radicals causing degradation of the lignocellulosic structures.

To demonstrate that such reactions are occurring at the bench level, a basal medium was prepared in deionized water. First, 100 mL of water was buffered with the stock of generic saturated citrate solution to obtain a pH approximately between 3.1 and 3.5. Following this, 1 drop (about 50 μL) of iron nano-particulate catalyst suspension and 1 ml of hydrogen peroxide (35% v/v) are added. The relative oxidation-reduction potential (ORP) of this preparation relative to water should be approximately >120 mV.

The system was tested with various permutations of the catalysts being tested. Dissolved oxygen was adopted as the benchmark parameter for assessing the robustness of the reaction. The reaction mixture was conditioned for 30 minutes at room temperature to jump start the development of classic Fenton and Haber-Weiss intermediates. Following conditioning, the reaction medium was adjusted with 50% NaOH solution to obtain pH of approximately 12.

FIG. 16 shows the results of a comparative study of dissolved oxygen generation in alkaline solution at pH 12.2 containing 0.35% of hydrogen peroxide, and the same medium containing 0.35% of hydrogen peroxide and traces of iron-based nanoparticles as a catalyst (CAT). Dissolved oxygen in deionized water (pH 6.5) containing 0.35% of hydrogen peroxide is included as reference.

By comparing the profiles of dissolved oxygen in water containing 0.35% of hydrogen peroxide at pH 6.5 and pH 12.2, it is apparent that oxygen is generated from the decomposition of hydrogen peroxide in an alkaline pH environment. However, comparison of oxygen profiles in alkalized water at pH 12.2 containing 0.35% of hydrogen peroxide with the same pH and hydrogen peroxide content, but amended with trace amounts of iron-based nanoparticulate catalyst, there is evident robust net gain of dissolved oxygen levels in complete reaction medium prepared as described above. Further measurements taken at 24 and 48 hours revealed that generation of oxygen in the complete reaction system is sustained at levels of 60 to 70 mg/ml, and 46 to 48 mg/ml in the system without iron catalyst.

This system appears to be “self-regenerating” based on the sustained net generation of oxygen measurable as dissolved oxygen. However, this catalytic reaction system cannot be explained by the principles of classic Fenton or Haber-Weiss reactions, which occur at acidic pH, preferably <5. These results are thus unexpected, because it was previously thought that the Fenton and Haber-Weiss reactions proceeded only at acidic pH.

### Example 16.1

### Catalytic Treatment of Various Biomasses under Alkaline Conditions

Manure is used as in this Example as an example of a recalcitrant lignocellulosic biomass. Other biomasses were assessed using the same procedure. The manure/biomass is washed thoroughly to eliminate the bulk of contaminants from the desired lignocellulosic material. The washed biomass is pre-treated in water adjusted to pH 12 with 50% NaOH solution, which allows for the extraction of available lignin, hemicellulose, and other water-soluble compounds, leaving cellulose in the solid fraction as described above. This process can be conducted at ambient temperature, although conducting this process at higher temperatures will enhance the efficiency of removal of available lignin and hemicellulose.

The solid fraction of the manure/biomass is then washed in water until neutral, and is then dispersed in water adjusted with saturated citrate to a pH in the range of about 3.2 to 3.5 to yield a manure slurry having a concentration of approximately 2.5% to 5% w/v, and trace amounts of iron-based nanoparticulate catalyst are added and thoroughly mixed into the slurry. The preparation is conditioned for approximately 30 minutes at room temperature, and then hydrogen peroxide (35% stock) is added to a final concentration of approximately 0.35% (v/v). The reaction is allowed to develop for approximately 30 minutes at room temperature, and the slurry is titrated with 50% NaOH to a final pH of approximately 12. The complete reaction mixture is then incubated on a hot plate at approximately 80° C. with constant stirring for several hours or as needed to complete the extraction process. The solid fraction of the slurry is then washed with running water to remove soluble contaminants.

The solid fraction of the extracted material is placed in distilled water to form an approximately 5% slurry and thoroughly mixed. Once a uniform slurry is obtained, this preparation is titrated with saturated citrate to obtain a pH level between 3.5 and 3.8. This preparation must be thoroughly mixed, and incubated at room temperature for few minutes. The pH is tested again, and re-adjusted if required. Iron-based nanoparticulate catalyst is added from a stock solution to a final concentration of approximately 1% (v/v of stock solution), and hydrogen peroxide is added from a 35% stock to a final concentration of approximately 0.35% (v/v) and mixed thoroughly. This preparation is incubated at room temperature for few minutes. The pH is checked and adjusted if required to the level of between about 3.5 and 3.8 as described above. The complete reaction mixture is then incubated on a hot plate at approximately 80° C. with constant stirring to yield the desired crystalline cellulose product.

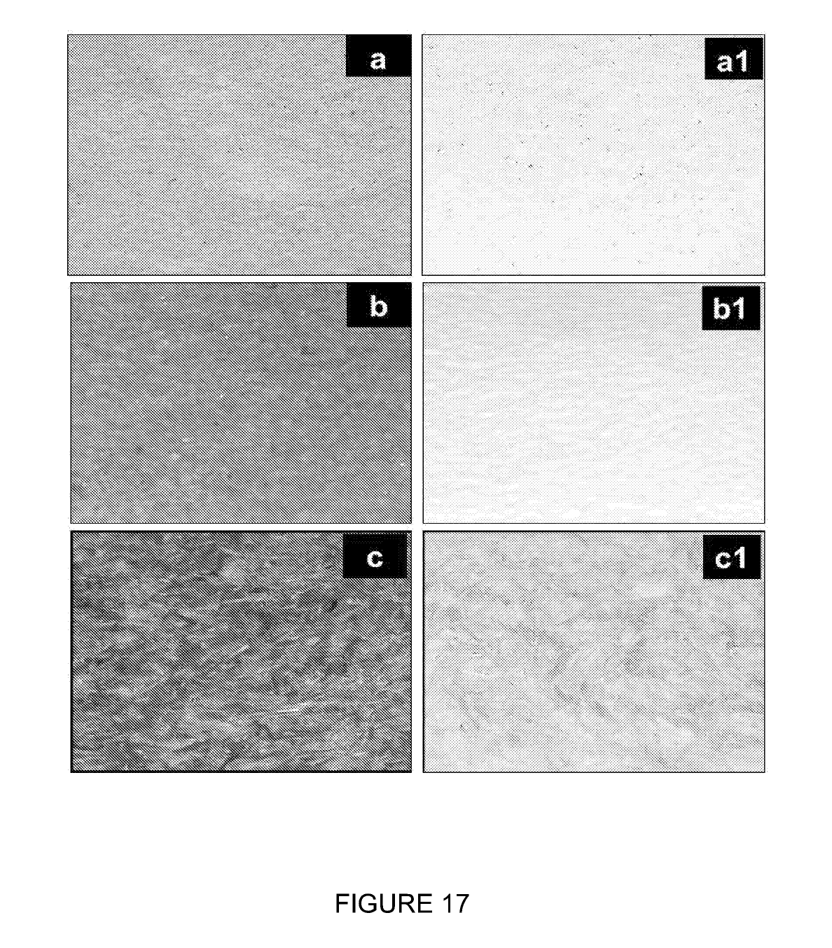

The above-described general process with a catalytic reaction step conducted at alkaline conditions was found to be effective in extracting crystalline cellulose from various other recalcitrant biomasses in addition to manure, for which catalytic treatment under acidic conditions only was not as effective. For example, as illustrated in FIG. 17 which shows photographs of treated biomass, (a) wheat straw, (b) oat hulls, and (c) flax shives, processed conducting the catalytic reaction step at acidic pH [left panel, (a), (b) and (c)] is not of as high quality or purity as biomass processed using the process described above, with a catalytic reaction step conducted at alkaline pH [right panel, (a1), (b1) and (c1)]. The image on the left panel shows a product that is considerably browner than the white product shown in the right image. It is apparent that the alkaline catalysis process allowed more effective lignin removal, as judged from the whiter color, and considerably increased depolymerisation of fibers.

With respect to the general difficulty of processing of various biomasses, wheat straw presents intermediate challenges—it is not as recalcitrant as manure, but is also not easily processed to produce desirable bioproducts using previously available procedures. Oat hulls and flax shives are included as examples of recalcitrant (i.e. difficult to process) biomasses. Flax shives are most problematic, followed by oat hulls. However, for all three biomasses, the addition of a catalytic reaction step conducted at alkaline pH facilitates effective processing of the biomass to produce crystalline cellulose, without the need for a harsh pre-treatment step with performic acid, which would ordinarily be required to process these biomasses effectively using a catalytic reaction step conducted only at acidic pH. The difficulty of processing manure is enhanced by the fact that it often contains elements of other recalcitrant biomass materials (for example, straw, shives, chaff) that are commonly used as bedding for animals. Biomasses used as bedding are low grade waste by-products which also present significant challenges in processing.

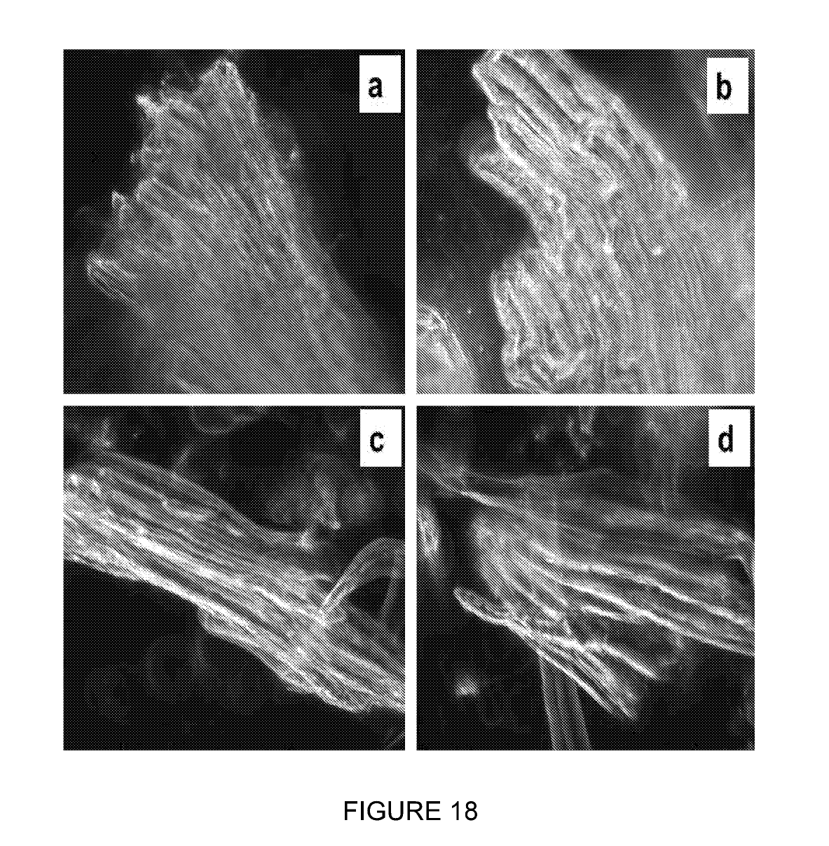

With reference to FIG. 18, the advantages of conducting the catalytic reaction with an alkaline catalysis step on the resultant structure of crystalline cellulose obtained from the biomass are shown. Samples of oat hulls and flax shives were subjected to catalytic treatment in basic medium at pH 12.0 as outlined above. When the results of catalytic treatment are compared microscopically, it is clear that an improved crystalline cellulose product is obtained. FIG. 18 shows examples of flax shives pulp processed with only an acidic catalysis step (panel a), and the effects of including an alkaline catalysis step (panels b, c, and d) according to the protocol described above. Noteworthy is a very compact architecture of the shive which was not subjected to an alkaline catalytic processing step (panel a), whereas the shives subjected to the catalytic process show considerable lessening of fibers (panel b).

Of note, in the absence of an alkaline catalysis step (panel a), the majority of the flax shives bundles remain resistant to degradation. However, when flax shives are subjected to an alkaline catalysis step, even the most persistent bundles show signs of degradation (panel b) evidenced by loosening of ties between individual fibers. These changes are associated with more effective lignin removal by the catalytic process, which is not accessible to other reactions. There is also considerably enhanced depolymerisation of fibers. The effect of catalysis is more evident as the process of degradation advances, where the fibre bundles clearly undergo size reduction (panel c) and eventually disintegrate into individual fibers (panel d). Of note, partial removal of amorphous cellulose is evidenced by more distinct light dispersion pattern when more crystalline cellulose features of the fiber is exposed (panels c and d). Images in FIG. 18 were photographed under dark field microscopy, with a magnification of 400×. The sample in panel a was untreated, while the images of panels b, c and d show different images of the degradation (panel b) or very advanced degradation (panels c and d) observed in the treated sample.

### Example 16.2

### Characterization of Crystalline Cellulose Obtained from Various Biomasses

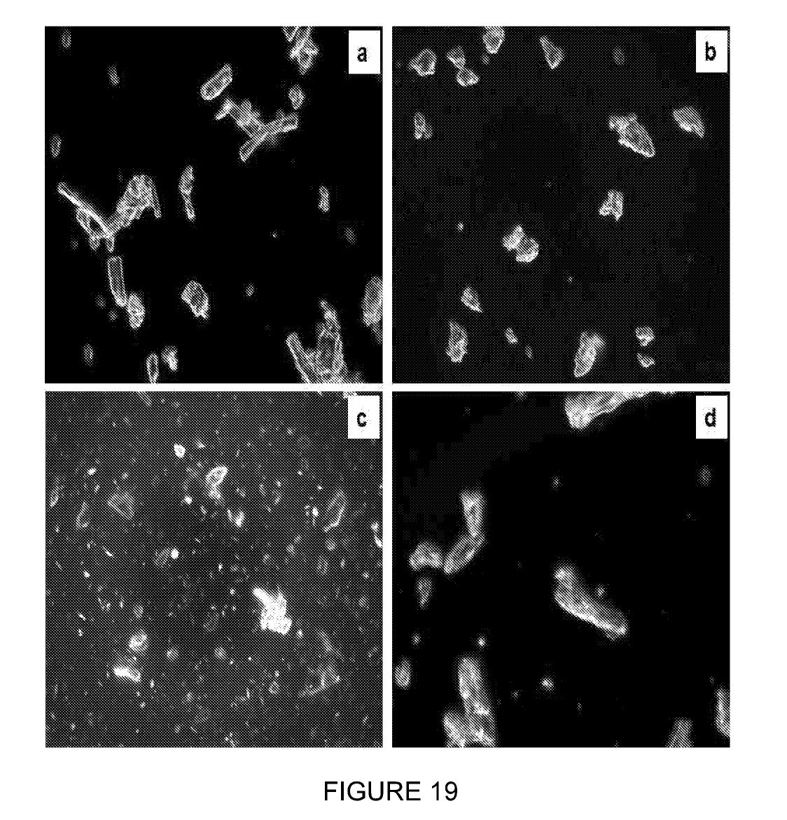

Crystalline cellulose extracted from several biomasses using the above described process was further analyzed under the light microscope. These analyses confirmed that crystalline cellulose harvested from manure, oat hulls, wheat straw, and cotton gin waste have all morphological and optical characteristics of pure cellulose. Light microscope images of exemplary crystalline cellulose crystals are shown in FIG. 19 for (a) manure, (b) wheat straw, (c) oat hulls, and (d) cotton gin waste using the above described process. Crystalline cellulose crystals were photographed under dark field. Original magnification is 400×.

The crystalline cellulose extracted from manure, oat hulls, and wheat straw samples were analyzed using used X-ray diffraction (XRD), using Empyrean, PANalytical, BV Lelyweg 1, 7602 EA, Almelo, The Netherlands. The instrument was operated with the following settings: Anode Material:Cu, K-Alpha1 [Å]:1.54069, K-Alpha2 [Å]:1.54443, K-Beta [Å]:1.36225, K-A2/K-A1 Ratio:0.50000, generator 40 mA, 45 Kv. Goniometer Radius [mm]:240.00, Dist. Focus-Diverg. Slit [mm]:100.00. Scan Axis: Gonio, Start Position [°2Th.]:7.0084, End Position [°2Th.]:79.9724, Step Size [°2Th.]:0.0170; Scan Step Tim [s]:101.6000, Scan was continuous; PSDLength [°2Th.]:2.12, Offset [°2Th.]:0.0000; Divergence slit was fixed, Slit Size [°]:0.5000, Specimen Length [mm]:10.00; Measurement Temperature [° C.]:25.00.

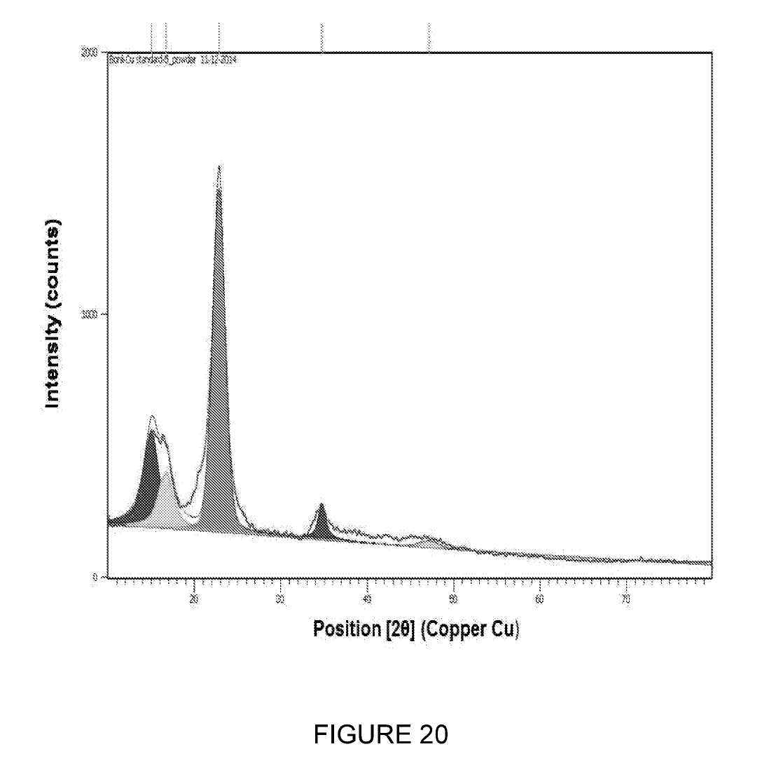

These analyses confirmed that crystalline cellulose harvested from manure, oat hulls, and wheat straw have all morphological and optical characteristics of pure cellulose, and showed exceptionally high crystallinity indices. An example of X-ray diffraction spectra of crystalline cellulose obtained from the manure sample using the above described protocol is presented in FIG. 20.

Calculation of the crystallinity index (CI) of the sample of crystalline cellulose obtained from manure using the process described above revealed exceptionally highly crystalline structure. It is noteworthy that based on X-ray diffraction spectra, the crystalline cellulose products obtained using a catalytic processing step conducted at alkaline pH showed routinely at least four crystalline peaks, and in some samples up to five crystalline structure peaks were identified, as evidenced in the sample shown in FIG. 20.

The crystallinity index (CI) of the cellulose was estimated using Segal's method (Segal et al. 1959) as per formula:

CI=I₀₀₂−Iₐₘ/I₀₀₂ 27)

where I₀₀₂ is the intensity of crystalline cellulose peak at °2θ=22.7° and Iₐₘ is the intensity at 2θ between 18.2° to 18.9° representative of amorphous cellulose. Estimated values of crystallinity from the X-ray diffraction analysis showed crystallinity indices for manure sample #1: 92%; for manure sample #2: 89%; for oat hulls: 75%; and for wheat straw: 76%.

While a number of exemplary aspects and embodiments are discussed herein, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true scope as construed with reference to the specification as a whole.

### REFERENCES

The following references are cited herein or are of interest to the subject matter disclosed herein. Each of these references is incorporated by reference in its entirety
Agency for Toxic Substances and Disease Registry (ATSDR), Toxicological Profile for Hydrogen Sulfide. 2006, US Department of Health and Human Services: Atlanta, US.
Andersen, H., Siegrist, H., Halling-Sorensen, B., Ternes, T. A. 2003. Fate of estrogens in a municipal sewage treatment plant. Environmental Science & Technology 37, 4021-4026.
Borst, G. H. A., 2001. Acute intoxification of pigs with hydrogen sulphide as a result of acidification of slums. Tijdschrift Voor Diergeneeskunde 126, 104-105.
Bray, W. C. and Gorin, M. H. 1932. J. Am. Chem. Soc. 54, 2124-2125.
Burnison, B. K., Hartmann, A., Lister, A., Servos, M. R., Ternes, T., Van der Kraak, G. 2003. A toxicity identification evaluation approach to studying estrogenic substances in hog manure and agricultural runoff. Environmental Toxicology & Chemistry 22, 2243-2250.
Ciganek, M., Neca, J. 2008. Chemical characterization of volatile organic compounds on animal farms. Veterinary Medicine 53, 641-651.
Ciganek, M., Ulrich, R., Neca, J., Raszyk, J. 2002. Exposure of pig fatteners and dairy cows to polycyclic aromatic hydrocarbons. Veterinary Medicine 47, 137-142.
Combalbert S, Bellet V, Dabert P, Bernet N, Balaguer P, Hernandez-Raquet G. 2012. Fate of steroid hormones and endocrine activities in swine manure disposal and treatment facilities. Water Res. 46, 895-906.
Ensing, B., Buda F., Blöchl P. E. and Baerends E. J. 2002. Phys. Chem. Chem. Phys. 4, 3619-3627.
Fangmeier, A., Hadwiger-Fangmeier, A., Van der Eerden, L., Jager, H. J. 1994. Effects of atmospheric ammonia on vegetation: a review. Environ. Pollut. 86, 43-82.
Forsberg, K. J., Reyes, A., Wang, B., Selleck, E. M., Sommer, M. O., Dantas, G. 2012. The shared antibiotic resistome of soil bacteria and human pathogens. Science 337, 1107-1111.
Fromme, H., Kuchler, T., Otto, T., Pilz, K., Muller, J., Wenzel, A. 2002. Occurrence of phthalates and bisphenol A and F in the environment. Water Research 36, 1429-1438.
Grierer, J., Reitberger, T., Yang, E., Yoon, B. 2001. Journal of Wood Chemistry and Technology, 21: 313- 341.
Heuer, H., Kopmann, C., Binh, C. T., Top, E. M., Smalla, K. 2009. Spreading antibiotic resistance through spread manure: characteristics of a novel plasmid type with low % G_C content. Environ. Microbiol. 11, 937-949.
Heuer, H., Schmitt, H., Smalla, K. 2011. Antibiotic resistance gene spread due to manure application on agricultural fields. Curr. Opin. Microbiol. 14, 236-243.
Holladay, J. E., Bozell, J. J., White, J. F., Johnson, D. 2007. Top-value-added chemicals from biomass. Volume II—Results of screening for potential candidates from biorefinery lignin. Pacific Northwest National Laboratory, U.S. Department of Energy. PNNL-16983.
Hutchings, N. J., Sommer, S. G., Andersen, J. M., Asman, W. A. H. 2001. A detailed ammonia emission inventory for Denmark. Atmos. Environ. 35, 1959-1968.
International Programme on Chemical Safety (IPCS), Hydrogen Sulfide. Concise International Chemical Assessment Document 53. 2003, WHO: Geneva.
Jiang, X., Morgan, J., Doyle, M. P. 2002. Fate of Escherichia coli O157:H7 in Manure-Amended Soil. Applied and Environmental Microbiology 68, 2605-2609.
Kjaer, J., Olsen, P., Bach, K., Barlebo, H. C., Ingerslev, F., Hansen, M., Sorensen, B. H. 2007. Leaching of estrogenic hormones from manure-treated structured soils. Environmental Science & Technology 41, 3911-3917.
Koike, S., Krapac, I. G., Oliver, H. D., Yannarell, A. C., Chee-Sanford, J. C., Aminov, R. I., Mackie, R. I. 2007. Monitoring and source tracking of tetracycline resistance genes in lagoons and groundwater adjacent to swine production facilities over a 3-year period. Appl. Environ. Microbiol. 73, 4813-4823.
Masarwa, M.; Cohen, H.; Meyerstein, C.; Hickman, D. L.; Bakac, A.; Espenson, J. H. 1988. J Am. Chem. Soc. 110, 4293-4297.
Monteny, G. J., Bannink, A., Chadwick, D. 2006. Greenhouse gas abatement strategies for animal husbandry. Agriculture, Ecosystems and Environment 112, 163-170.
Norrander J, Kempe T, Messing, J. 1983. Construction of improved M13 vectors using oligodeoxynucleotide-directed mutagenesis. Gene, 26(1), 101-106.
Oenema, O., Kros, H., de Vries, W. 2003. Approaches and uncertainties in nutrient budgets: implications for nutrient management and environmental policies. Eur. J. Agron. 20, 3-16.
Olesen, J. E., Schelde, K., Weiske, A., Weisbjerg, M. R., Asman, W. A. H., Djurhuus, J. 2006. Modelling greenhouse gas emissions from European conventional and organic dairy farms. Agr. Ecosyst. Environ. 112, 207-220.
Petersen, S. O. Blanchard, M., Chadwick, D., Del Prado, A., Edouard, N., Mosquera, J., Sommer, S. G. 2013. Manure management for greenhouse gas mitigation. Animal 7, s2, 266-282.
Segal, L., Creely, J. J., Martin-Jr, A. E., Conrad, C. M. 1959. Text. Res. J. 29, 786-794.
Semenov, A. V., van Overbeek, L., van Bruggen, A. H. C. 2009. Percolation and Survival of Escherichia coli O157:H7 and Salmonella enterica Serovar Typhimurium in soil amended with contaminated dairy manure or slurry. Applied and Environmental Microbiology 75, 3206-3215.
Septimus, E. J., Owens, R. C., Jr. 2011. Need and potential of antimicrobial stewardship in community hospitals. Clin. Infect. Dis. 53(Suppl 1), S8-S14.
Sivapalasingam, S., Friedman, C. R., Cohen, L., Tauxe, R. V. 2004. Fresh produce: a growing cause of outbreaks of foodborne illness in the United States, 1973 through 1997. J. Food Prot. 67, 2342-2353.
Walczak, J. J., Xu, S. 2011. Manure as a source of antibiotic-resistant Escherichia coli and enterococci: a case study of a Wisconsin, USA family dairy farm. Water Air Soil Pollut. 219, 579-589.
Wichmann F, Udikovic-Kolic N, Andrew S, Handelsman J. 2014. Diverse antibiotic resistance genes in dairy cow manure. mBio 5(2), e01017-13
Zheng, W., Yates, S. R., Bradford, S. A. 2008. Analysis of steroid hormones in a typical dairy waste disposal system. Environmental Science & Technology 42, 530-535.

1. A process for treating a waste stream comprising:
subjecting the waste stream to a conditioning step under acidic or basic conditions; and
subjecting the conditioned waste stream to a catalytic reaction step using a transition metal catalyst, wherein the transition metal catalyst optionally comprises an iron-based nanoparticulate catalyst, and hydrogen peroxide to produce a treated waste stream, wherein the hydrogen peroxide is optionally added to the waste stream in at a concentration of about 0.35% to about 1% v/v.

2. A process as defined in claim 1, wherein subjecting the waste stream to a conditioning step under acidic conditions comprises reducing the pH of the waste stream below about 1.5, and wherein the pH is optionally reduced by adding hydrochloric acid (HCl), nitric acid (HNO₃), sulfuric acid (H₂SO₄), phosphoric acid (H₃PO₄), or a combination thereof to the waste stream, wherein optionally the hydrochloric acid (HCl), nitric acid (HNO₃), sulfuric acid (H₂SO₄), phosphoric acid (H₃PO₄), or combination thereof is added slowly to the waste stream to titrate the waste stream to a desired pH.

3. A process as defined in claim 1, wherein subjecting the waste stream to a conditioning step under basic conditions comprises increasing the pH of the waste stream to about 12 to 13, and wherein the pH is optionally increased by adding sodium hydroxide (NaOH), potassium hydroxide (KOH), ammonium hydroxide (NH₄OH), or a combination thereof to the waste stream, wherein optionally the sodium hydroxide (NaOH), potassium hydroxide (KOH), ammonium hydroxide (NH₄OH), or combination thereof is added slowly to the waste stream to titrate the waste stream to a desired pH.

4. (canceled)

5. A process as defined in claim 1, wherein subjecting the waste stream to a conditioning step comprises first decreasing the pH of the waste stream to less than about 1.5 by addition of a strong acid, holding the waste stream at acidic pH for a treatment period, and subsequently increasing the pH of the waste stream to about 12 to 13 by adding a strong base; or wherein subjecting the waste stream to a conditioning step comprises first increasing the pH of the waste stream to about 12 to 13 by adding a strong base, holding the waste stream at a basic pH for a treatment period, and subsequently decreasing the pH of the waste stream to about 1.5 by adding a strong acid, wherein the treatment period optionally comprises at least 16 to 24 hours.

6. (canceled)

7. A process as defined in claim 1, wherein:
the acid or base used to conduct the conditioning step is selected to provide a desired nutrient in a final fertilizer product produced from the treated waste stream;
wherein the dry matter content of the waste stream to be treated is in the range of about 2% to about 20%;
the conditioning step is conducted at ambient temperature;
the conditioning step is conducted for at least about 16 to 24 hours;
the conditioning step is conducted at ambient pressure, and/or
wherein storage of the conditioned material is conducted at ambient pressure.

8. A process as defined in claim 1, wherein the waste stream is stored for a period of time after the conditioning step, and wherein the period of time optionally comprises up to one week, up to one month, up to two months, up to three months, up to six months, or up to one year.

9. A process as defined in claim 8, wherein the pH of the waste stream is periodically checked during the period of time, and wherein additional acid is added to decrease the pH of the conditioned waste stream below about 1.5 if the pH increases to about 2, wherein the pH of the waste stream is optionally checked at least once every two weeks during the period of time; and/or wherein the pH of the waste stream is optionally monitored continuously.

10. A process as defined in claim 8, wherein the pH of the waste stream is periodically checked during the period of time, and wherein additional base is added to increase the pH of the conditioned waste stream to about 12 to 13 if the pH decreases to about 11.5, wherein the pH of the waste stream is optionally checked at least once every two weeks during the period of time; and/or wherein the pH of the waste stream is optionally monitored continuously.

11. (canceled)

12. (canceled)

13. A process as defined in claim 1, wherein:
the conditioning step is conducted at the site of collection of the waste stream, optionally on a farm where manure is collected from a livestock operation, and optionally using manure that has not been stored for an appreciable period of time;
the treated waste stream is harvested after the catalytic reaction step;
the treated waste stream is sterile or nearly sterile;
the treated waste stream is used as a fertilizer, optionally in agricultural, horticulture or landscape applications;
the treated waste stream is applied directly to a field as a fertilizer in liquid form, optionally in agricultural, horticultural or landscape applications;
the treated waste stream is dewatered and applied to a field in granular form, optionally in agricultural, horticultural or landscape applications;
the treated waste stream is used as a fertilizer in organic farming;
the treated waste stream has little or no perceptible odor;
potash salts are generated by addition of an acid, wherein the acid optionally comprises hydrochloric acid (HCl), nitric acid (HNO₃), sulfuric acid (H₂SO₄), phosphoric acid (H₃PO₄), or a combination thereof; wherein the acid is optionally added during the conditioning step; wherein potassium hydroxide (KOH) is optionally added to produce the potash salts, and wherein the potash salts optionally comprise potassium chloride (KCl), potassium sulfate (K₂SO₄), potassium nitrate (KNO₃), potassium phosphates (KₓPO₄), or a combination thereof;
the conditioning step is carried out under alkaline conditions to preserve organic and inorganic major elements and/or micronutrient elements present in the waste stream, wherein the organic and inorganic major elements optionally comprise carbon, nitrogen, or phosphorous; and wherein the micronutrient elements optionally comprise calcium, magnesium, iron, cobalt, chromium, copper, iodine, manganese, selenium, zinc and molybdenum; and/or
the treated waste stream contains no or a very low concentration of toxins, wherein the toxins optionally comprise environmental pollutants, antibiotics, hormones and/or other drugs, and wherein the environmental pollutants optionally comprise phenol, nonylphenols, phthalates, bisphenol A, polycyclic aromatic hydrocarbons, dioxins, PCBs, and/or products of plastic breakdown, and wherein the treated waste stream contains no or a very low concentration of intact genetic material, wherein the genetic material optionally comprises DNA or RNA.

14. A process as defined in claim 1, wherein the catalytic reaction step comprises adding hydrogen peroxide and an iron-based nanoparticulate catalyst obtained by oxidizing a highly reduced solution of iron, optionally wherein the iron-based nanoparticulate catalyst is provided in a stock solution having a concentration in the range of 1.0 to 1.5 mg/mL, and optionally wherein the amount of stock solution added to the waste stream is in the range of about 0.15% to 1.5% v/v.

15. (canceled)

16. A process as defined in claim 1, wherein:
the catalytic reaction step is conducted at a temperature in the range of about 50° C. to about 95° C.;
the catalytic reaction step is conducted for between 1 hour and 24 hours;
the catalytic reaction step is conducted at ambient temperature;
the catalytic reaction step is conducted for a period of several days to several months; and/or
the catalytic reaction step is conducted at a pressure above atmospheric pressure, optionally at a gauge pressure between about 30 to about 50 psi.

17. (canceled)

18. A process as defined in claim 1, further comprising producing useful products from the waste stream, wherein the useful products optionally comprise lignin, crystalline cellulose and/or platform chemicals.

19. A process as defined in claim 1, wherein lignin is recovered from the waste stream or from a liquid fraction remaining after the catalytic reaction step using a hot alkaline extraction process, wherein optionally lignin is recovered by titrating the pH of the liquid fraction to an alkaline pH, optionally in the range of about 12 to 14, subjecting the liquid fraction to a hot alkaline extraction at a temperature in the range of about 80° C. to 100° C., and recovering lignin; wherein optionally the hot alkaline extraction is conducted for at least about 12 hours, and wherein lignin is optionally recovered by passing the treated material through a paper filter to recover lignin.

20. (canceled)

21. A process as defined in claim 1, wherein crystalline cellulose is recovered from a solid fraction remaining after the catalytic reaction step, wherein optionally the crystalline cellulose is recovered from the solid fraction by microfiltration, ultrafiltration or nanofiltration.

22. (canceled)

23. A process as defined in claim 1, wherein:
the waste stream comprises manure mixed with a bedding material, wherein lignin and crystalline cellulose are recovered from the waste stream, and wherein the bedding material optionally comprises straw, wood chips, sawdust or shredded paper;
the waste stream comprises lignocellulosic biomass from an agricultural or forestry operation, an industrial waste stream, effluent produced by recovering oil from tar sands, or municipal sewage effluent; or
the waste stream comprises manure, and wherein the manure is optionally from cattle, sheep, goats, pigs, horses, zoo animals and/or chickens, turkeys, ducks or other poultry.

24. (canceled)

25. (canceled)

26. A process for producing cellulose from recalcitrant lignocellulosic biomass, the process comprising:
combining the biomass with a transition metal catalyst, wherein the transition metal catalyst optionally comprises an iron-based nanoparticulate catalyst, a polyvalent carboxylic acid and hydrogen peroxide;
incubating the reaction mixture at an alkaline pH; and
recovering cellulose.

27. A process for producing bioproducts from lignocellulosic biomass, the process comprising:
extracting lignin and/or hemicellulose from a soluble fraction of the lignocellulosic biomass under alkaline conditions, wherein the alkaline conditions optionally comprise a pH of about 11 to about 13, optional a pH of approximately 12, at a temperature in the range of 10° C. to 160° C., optionally 60° C. to 95° C., optionally for a period of between about 30 minutes and 10 hours;
washing the lignocellulosic biomass until the pH of the lignocellulosic biomass is approximately neutral;
adding a polyvalent carboxylic acid, trace amounts of a transition metal catalyst, wherein the transition metal catalyst optionally comprises an iron-based nanoparticulate catalyst, and hydrogen peroxide to the lignocellulosic biomass to produce a reaction mixture, wherein the concentration of biomass in the reaction mixture is optionally in the range of 2.5% to 5% w/v, wherein the pH is optionally reduced to a pH in the range of 2.5 to 5, wherein the polyvalent carboxylic acid optionally comprises an aqueous solution saturated with citrate having a pH in the range of 3.2 to 3.5;
increasing the pH of the reaction mixture to an alkaline pH;
incubating the reaction mixture at a predetermined temperature for a treatment period; and
recovering bioproducts from the treated reaction mixture, wherein the bioproducts optionally comprise lignin, hemicellulose, cellulose, and/or crystalline cellulose.

28. A process for producing bioproducts from lignocellulosic biomass as defined in claim 27 wherein:
the alkaline pH comprises a pH greater than about 8, optionally in the range of 10-14, and optionally in the range of 12-13;
the trace amounts of iron-based nanoparticulate catalyst comprise between about 0.001% and 1% w/v, optionally approximately 0.1% w/v;
the concentration of hydrogen peroxide in the reaction mixture comprises in the range of about 0.1% to about 1% v/v;
the predetermined temperature comprises a temperature between 10° C. and 160° C., optionally in the range of 80° C. to 100° C., optionally in the range of 95° C. to 100° C.;
the reaction mixture is incubated for about 5 to about 30 minutes at ambient temperature before the step of increasing the pH of the reaction mixture to an alkaline pH;
the treatment period comprises a time period between about 30 minutes and about ten hours;
the reaction mixture is incubated with constant stirring during the treatment period;
the polyvalent carboxylic acid comprises citric acid, malic acid, oxalic acid, ascorbic acid or aconitic acid;
and/or
a wash step is performed prior to the step of producing the reaction mixture.

29. A process as defined in claim 28, further comprising:
recovering lignin and/or hemicellulose from the soluble fraction of the treated reaction mixture; and
further processing the insoluble fraction of the treated reaction mixture to recover crystalline cellulose, wherein further processing the insoluble fraction optionally comprises:
washing the insoluble fraction;
adding a polyvalent carboxylic acid to the insoluble fraction to form an acidic slurry, wherein the pH of the slurry is optionally in the range of about 2.5 to about 5, optionally 3.5 to 3.8, wherein the polyvalent carboxylic acid optionally comprises citric acid, and wherein the concentration of the insoluble fraction in the slurry optionally comprises about 5% w/v;
adding a transition metal catalyst, wherein the transition metal catalyst optionally comprises an iron-based nanoparticulate catalyst, and hydrogen peroxide to the insoluble fraction to form a second reaction mixture, wherein the iron-based nanoparticulate catalyst is optionally added to a concentration of about 1% w/v and the hydrogen peroxide is optionally added to a final concentration in the range of about 0.1% to 1.0% v/v;
incubating the second reaction mixture for a further treatment period at a further treatment temperature, wherein the further treatment period optionally comprises between four and ten hours, wherein the further treatment temperature optionally comprises between 10° C. and 160° C., optionally in the range of 80° C. to 100° C., optionally in the range of 90° C. to 95° C., wherein the second reaction mixture is optionally constantly stirred during the further treatment period; and
recovering crystalline cellulose, wherein recovering crystalline cellulose optionally comprises centrifugation, filtration, or spray drying.

30. A process for producing bioproducts from lignocellulosic biomass as defined in claim 26, wherein:
the lignocellulosic biomass comprises an agricultural or forestry waste stream, a woody material, wherein the woody material optionally comprises wood chips, sawdust, wood waste, wood pulp, or pulping byproducts, cereal grain straw, hemp straw, flax straw, shives or hurd from flax or hemp, hulls, wherein the hulls optionally comprise oat hulls or rice hulls, cotton gin waste, chaff, grass, wherein the grass optionally comprises Miscanthus (elephant grass), corn stover, corn husks, sugarcane bagasse, plant parts, fruits, vegetables, hemp, oats, rice, corn, weeds, aquatic plants, hay, paper, paper products, paper waste or peat; or
the lignocellulosic biomass comprises a recalcitrant biomass, wherein the recalcitrant biomass optionally comprises manure, optionally solid or liquid manure obtained from cattle, horses, pigs, poultry, sheep, goats, or zoo animals, flax shives, oat hulls, cotton gin waste, wood or straw; a woody material, wherein the woody material optionally comprises wood chips, sawdust, wood waste, wood pulp or pulping byproducts; cereal grain straw, hemp straw, flax straw, or hurd from flax or hemp, hulls, wherein the hulls optionally comprise oat hulls or rice hulls, cotton gin waste, chaff, grass wherein the grass optionally comprises Miscanthus (elephant grass), corn stover, corn husks, sugarcane bagasse, hemp, weeds, hay, or peat.

31. (canceled)
